(19) United States
(12) Patent Application Publication
(10) Pub. No.: US 2025/0043208 A1
(43) Pub. Date: Feb. 6, 2025

(54) LUBRICIOUS SURFACES, SYSTEMS AND METHODS FOR MAKING THE SAME

(71) Applicant: LiquiGlide Inc., Cambridge, MA (US)

(72) Inventors: Sebastian HEISE, Malden, MA (US); Quan XIE, Malden, MA (US); Hyukmin KWON, Boston, MA (US); Taylor A. FARNHAM, Cambridge, MA (US); Jonathan David SMITH, Cambridge, MA (US); Kripa VARANASI, Lexington, MA (US)

(21) Appl. No.: 18/610,857

(22) Filed: Mar. 20, 2024

Related U.S. Application Data
(63) Continuation of application No. 17/502,381, filed on Oct. 15, 2021, now abandoned.
Application No. 17/502,381 is a continuation of application No. PCT/US2020/028289, filed on Apr. 15, 2020.
(60) Provisional application No. 62/834,632, filed on Apr. 16, 2019.

(51) Int. Cl. C10M 109/00; B05C 7/02; B65D 23/02; B65D 25/14; C10M 159/00; C10M 171/02; C10M 171/06; C10N 20/00; C10N 20/02

(52) U.S. Cl. CPC C10M 109/00; B05C 7/02; B65D 23/02; B65D 25/14; C10M 159/00; C10M 171/02; C10M 171/06; C10N 2020/02; C10N 2020/077

(57) ABSTRACT

Embodiments, described herein relate generally to devices, systems, apparatus, and methods for producing lubricious surfaces that increase the ease of communication of viscous liquids across the same. The apparatus can include a container having an inner surface and a lubricating liquid disposed on a surface, the lubricating liquid including a surfactant. In some embodiments, a sprayer hub can rotate about a center axis and deliver the lubricating liquid to the inner surface. In some embodiments, a contact liquid can fill at least a portion of the container. In some embodiments, the surfactant can be an amphiphilic molecule that is substantially immiscible with the lubricating liquid and at least partially miscible with the contact liquid. In some embodiments, the surfactant can form a barrier at an interface between the lubricating liquid and the contact liquid.

### CROSS-REFERENCE TO RELATED APPLICATIONS

This application is a continuation of U.S. patent application Ser. No. 17/502,381, filed Oct. 15, 2021 and entitled “Lubricious Surfaces, Systems and Methods for Making the Same”, which is a continuation of International Patent Application No. PCT/US2020/028289, filed Apr. 15, 2020 and entitled “Lubricious Surfaces, Systems and Methods for Making the Same”, which claims priority to and the benefit of U.S. Provisional Patent Application Ser. No. 62/834,632 entitled, “Lubricious Surfaces, Systems and Methods for Making the Same,” filed Apr. 16, 2019, the disclosures of which are incorporated herein by reference in their entireties.

### BACKGROUND

Embodiments described herein relate generally to devices, systems and methods for producing lubricious surfaces.

Viscous liquids are ubiquitous in manufacturing. Often, viscous liquids and semi solids are manufactured or stored in metal tanks and transported through pipes. Other times viscous liquids and semi solids come into contact with non-enclosed surfaces. The interface between viscous liquids and the contact surface of the tank, pipe or other surface is a no-slip boundary, meaning that viscous liquids stick to these surfaces, resulting in costly inefficiencies, including loss of product and costs associated with cleaning tanks and pipes coated with viscous liquids, including but not limited to labor costs and waste-water disposal costs. Under some circumstances, cleaning tanks can result in safety risks for people who have to clean tanks in confined spaces.

Engineered surfaces are surfaces dimensioned such that specific characteristics, properties, and interactions occur that otherwise would not likely occur. The advent of micro/nano-engineered surfaces in the last decade has opened up new techniques for enhancing a wide variety of physical phenomena in thermofluids sciences. For example, the use of micro/nano surface textures has provided non-wetting surfaces capable of achieving less viscous drag, reduced adhesion to ice and other materials, self-cleaning, and water repellency. These improvements result generally from diminished contact (i.e., less wetting) between the solid surfaces and adjacent liquids.

One type of non-wetting surface of interest is a super hydrophobic surface. In general, a super hydrophobic surface includes micro/nano-scale roughness on an intrinsically hydrophobic surface, such as a hydrophobic coating. Super hydrophobic surfaces resist contact with water by virtue of an air-water interface within the micro/nano surface textures that allow for a higher proportion of the surface area beneath the droplet to be air.

One of the drawbacks of existing non-wetting surfaces (e.g., super hydrophobic, super oleophobic, and super metallophobic surfaces) is that they are susceptible to impalement, which destroys the non-wetting capabilities of the surface. Impalement occurs when a liquid in contact with the surface displaces the air pockets or air layer that is trapped within the surface textures: i) the air pockets can be collapsed by external wetting pressures (such as when the superhydrophobic surface is exposed to large hydrostatic pressures or impacting liquids), ii) the air pockets can diffuse away into the surrounding liquid, iii) the surface can lose robustness upon damage to the texture, iv) the air pockets may be displaced by low surface tension liquids unless special texture design is implemented, and v) condensation or frost nuclei, which can form at the nanoscale throughout the texture, can completely transform the wetting properties and render the textured surface highly wetting. Previous efforts to prevent impalement have focused on reducing surface texture dimensions from micro-scale to nano-scale, which has had some success in preventing impalement in static or non-industrial environments, though to a lesser extent in dynamic, industrial, and other environments for which surface interactions can be forceful.

Another drawback with existing non-wetting surfaces is that they are susceptible to ice formation and adhesion. For example, when frost forms on existing super hydrophobic surfaces, the surfaces become hydrophilic. Under freezing conditions, water droplets can stick to the surface, and ice may accumulate. Removal of the ice can be difficult because the ice may interlock with the textures of the surface. Similarly, when these surfaces are exposed to solutions saturated with salts, for example as in desalination or oil and gas applications, scale builds on the surfaces, which results in loss of functionality. Similar limitations of existing non-wetting surfaces include problems with hydrate formation, and formation of other organic or inorganic deposits on the surfaces.

Thus, there is a need for non-wetting surfaces that are more robust. In particular, there is a need for non-wetting surfaces that are more durable and can maintain slippery properties even after repeated use and when used in more severe manufacturing conditions and other environments.

### SUMMARY

Embodiments, described herein relate generally to devices, systems, apparatus, and methods for producing lubricious surfaces that increase the ease of communication of viscous liquids across the same. The apparatus can include a container having an inner surface and a lubricating liquid disposed on a surface, the lubricating liquid including a surfactant. In some embodiments, a sprayer hub can rotate about a center axis and deliver the lubricating liquid to the inner surface. In some embodiments, a contact liquid can fill at least a portion of the container. In some embodiments, the surfactant can be an amphiphilic molecule that is substantially immiscible with the lubricating liquid and at least partially miscible with the contact liquid. In some embodiments, the surfactant can form a barrier at an interface between the lubricating liquid and the contact liquid. In some embodiments, the lubricating liquid can be substantially immiscible with the contact liquid, and/or can have a thickness of less than about 200 microns and/or can have a receding contact angle of less than about 25 degrees in the presence of the contact liquid. In some embodiments, a liquid delivery mechanism can be configured to transfer the lubricating liquid to the coating.

### BRIEF DESCRIPTION OF THE DRAWINGS

FIG. 1 is a block diagram illustrating an apparatus that includes an inner surface, a lubricating liquid disposed thereon, and a liquid delivery mechanism configured to communicate the lubricating liquid from a reservoir to the inner surface, according to an embodiment.

FIG. 2 shows a flow chart illustrating a method for forming a liquid-encapsulated surface using a liquid delivery mechanism, according to an embodiment.

FIG. 3 is a schematic illustration of a liquid delivery mechanism configured to dispose a lubricating liquid onto an inner surface of a container and a reservoir configured to contain a replenishing supply of lubricating liquid, according to an embodiment.

FIG. 4 is a schematic illustration of a liquid delivery mechanism configured to dispose a lubricating liquid onto an inner surface of a container and a reservoir configured to contain a replenishing supply of lubricating liquid, according to an embodiment.

FIG. 5 is a bottom view of the rotating arm apparatus shown in FIG. 4.

FIG. 6 is a schematic illustration of a liquid delivery mechanism configured to dispose a lubricating liquid onto an inner surface of a container and a mechanical arm fitted with spray guns necessary to supply the desired amount of lubricating liquid, according to an embodiment.

FIG. 7 is a schematic illustration of a liquid delivery mechanism configured to dispose a lubricating liquid onto an inner surface of a container, according to an embodiment.

FIG. 8A shows an inner surface of a container with a plurality of droplets of a lubricating liquid disposed thereon, according to an embodiment.

FIG. 8B shows a dispersed film of the lubricating liquid across the inner surface of the container and the remaining droplets of lubricating liquid disposed on the inner surface above a fill line of a contact liquid, according to an embodiment.

FIG. 9A shows an inner surface of a container with a plurality of droplets of a lubricating liquid disposed thereon and a contact liquid disposed in an inner volume of the container, a fill line of the contact liquid causing dispersion of the plurality of droplets across the inner surface to form a liquid-encapsulated surface, according to an embodiment. FIG. 9B is a blown-up illustration of box A from FIG. 9A.

### DETAILED DESCRIPTION

Some known engineered surfaces with designed chemistry and roughness, possess substantial non-wetting (hydrophobic) properties, which can be extremely useful in a wide variety of commercial and technological applications. Some hydrophobic surfaces are inspired by nature, such as for example, the lotus plant which includes air pockets trapped within the micro or nano-textures of the surface, increasing the contact angle of a contact liquid (e.g., water or any other aqueous liquid) disposed on the hydrophobic surface. As long as these air pockets are stable, the surface continues to exhibit hydrophobic behavior. Such known hydrophobic surfaces that include air pockets, however, present certain limitations including, for example: i) the air pockets can be collapsed by external wetting pressures, ii) the air pockets can diffuse away into the surrounding liquid, iii) the surface can lose robustness upon damage to the texture, iv) the air pockets may be displaced by low surface tension liquids unless special texture design is implemented, and v) condensation or frost nuclei, which can form at the nanoscale throughout the texture, can completely transform the wetting properties and render the textured surface highly wetting. These limitations are especially true for engineered surfaces in dynamic, industrial, and severe manufacturing environments.

Non-wetting surfaces can also be formed by disposing a liquid-impregnated or liquid-encapsulated surface on a substrate. Such liquid-impregnated or liquid-encapsulated surfaces can be non-wetting to any liquid, i.e., omniphobic (e.g., super hydrophobic, super oleophobic, or super metallophobic), can be configured to resist ice and frost formation, and can be highly durable. Liquid-impregnated surfaces can be disposed on any substrate, for example, on the inner surface of pipes, containers, or vessels, and can be configured to present a non-wetting surface to a wide variety of products, for example, food products, pharmaceuticals, over-the-counter drugs, nutraceuticals, health and beauty products, industrial greases, inks, bitumen, cement, adhesives, hazardous waste, consumer products, or any other product, such that the product can be evacuated, detached, or otherwise displaced with substantial ease on the liquid-impregnated surface.

For many applications, it may be desirable to apply a liquid to a surface that has little or no texture. The problem with applying a liquid to a surface to provide lubrication in the absence of texture is that, unless certain criteria described herein are satisfied, the only way to maintain lubricity for any significant period of time is to apply a thick layer of liquid. However, because all or nearly all of the liquid will be quickly stripped from the smooth surface or drained under gravity, applying the amount of liquid necessary to maintain lubricity can result in high-levels of liquid in the product (contact liquid), which could result in significant issues, including compromised product properties. Furthermore, once most of the liquid is removed, the remaining liquid layer can become unstable, which leads to a surface that is not slippery (unless certain criteria described herein are satisfied). Furthermore, depending on the price of the liquid, applying a thick layer of lubricant can also be prohibitively expensive. Therefore, it can be desirable to maintain a lubricious surface with a thin layer of liquid, which will be more cost effective and result in minimal product contamination.

The speed at which a product can slide increases with the slip length of the surface, b. The slip length, b, for a stable liquid surface is given by b=(C*h+t)*μ_{product}/μₒ, where h is the thickness of the film of liquid stabilized between the textures by capillary forces, or stabilized by van der Waals forces, as described herein, and t is the thickness of a layer of mobile liquid (that is, a mobile encapsulating liquid or mobile lubricating liquid) that is not stabilized by capillary forces or by van der Waals forces. C is a constant between 0 and 1 (approaching 1 if textures are sparse or nonexistent). Increasing the thickness of the coating, h+t, by adding mobile liquid of thickness, t, therefore increases the slip length, which increases the mobility of the liquid-impregnated, or lubricious surface. The equation for slip length can be reorganized as b=(C*h)*μ_{product}/μₒ+M*μ_{product}. The contribution to the slip length due to the mobile excess liquid, is M*μ_{product}, where M=t/μₒ. We will henceforth refer to M as the mobility parameter for the mobile liquid. In some embodiments, the mobility parameter, M, can be between 10⁻⁶ m/(Pa*s) and 10⁻⁵ m/(Pa*s), between 10⁻⁵ m/(Pa*s) and 10⁻⁴ m/(Pa*s), between 10⁻⁴ m/(Pa*s) and 10⁻³ m/(Pa*s) or between 10⁻³ m/(Pa*s) and 10⁻² m/(Pa*s). In some embodiments the mobility parameter M is greater than about 10⁻⁶ m/(Pa*s) or greater than about 10⁻⁵ m/(Pa*s) or greater than about 10⁻⁴ m/(Pa*s) or greater than about 10⁻³ m/(Pa*s) or greater than about 10⁻² m/(Pa*s).

In some embodiments the impregnating or encapsulating liquid can be shear thinning, or have a non-zero yield stress, such that the impregnating liquid is immobile or has low mobility while in static contact with the contact liquid, thereby greatly enhancing the longevity of the coating. When contact liquid flows into or out of the tank or container, the motion of the contact liquid leads to shear stress on the surface that reduces its viscosity and enables sufficient reduction in viscosity (increase in mobility parameter) such that the liquid can spread beneath the product (in the case of filling) and allow complete or nearly complete de-wetting (during evacuation).

In some embodiments, the mobile liquid may be a different lubricating liquid than the underlying lubricating liquid (the impregnating or encapsulating liquid). In some embodiments, the mobile lubricating liquid can be immiscible with the impregnating or encapsulating liquid. Alternatively, in some embodiments it may be desirable that the mobile excess liquid be partially or completely miscible with impregnating or encapsulating liquid. In some embodiments it may be desirable that the excess mobile liquid have a lower viscosity than the impregnating or encapsulating liquid. In such embodiments, a relatively high viscosity of impregnating or encapsulating liquid can be desirable to enhance robustness during use or storage of the product, while the low viscosity liquid of the excess mobile liquid provides a low enough mobility parameter such that the product can readily de-wet the inner surface of the tank during evacuation. In embodiments that the lower viscosity excess mobile liquid is miscible with the encapsulating and impregnating liquid, it is important the liquids be selected such that the time require for them to complete or substantially dissolve into each other is less than the time that product is stored in the tank or container (after complete or substantial mixing of the two liquids, the robustness of the higher viscosity impregnating or encapsulating layer would be lost). In other words, the liquids must remain substantially stratified during the time that contact liquid is held in the tank or container. In some embodiments it may be desirable that either mobile excess liquid is shear thinning or has a nonzero yield stress or the impregnating or encapsulating liquid is shear thinning or has nonzero yield stress. For any of the embodiments described in this section it can be desirable that the mobile excess liquid be immiscible or substantially immiscible with the contact liquid.

Nevertheless, the above equation is only a valid estimate of average slip length if the product cannot pin to the surface, or valid up until such pinning occurs. For example, a smooth surface with a layer of mobile liquid of thickness, t, but with h=0 (i.e., no stabilized layer of liquid, beneath the mobile liquid). In typical dynamic environments (e.g., mixing or pipeflow, or vibration from transportation), fluctuations in pressure within the moving product can cause the mobile liquid-product interface to become curved, and thus the product will come into contact with the solid surface beneath and become pinned. Gradually this area of contact will expand and the lubrication effect will be lost. In order to prevent such pinning, the underlying surface can be engineered with a texture or chemistry that (1) can stably contain liquid beneath the product, and (2) has ϕ that low enough that the product cannot become pinned. In some cases, the first criteria can be satisfied if cos θ_{os(e),receding}<(1−ϕ)/(r−ϕ)=θ_{c}. (cos θ_{os(e),receding}<1/r=θₑ* is a reasonable approximation when ϕ is low), where r is the Wenzel roughness of the surface of an inner surface of a container, and where θ_{os(e),receding} is receding contact angle of the lubricating liquid (e.g., oil, subscript ‘o’) on a smooth surface comprised of the same material as solid features (subscript ‘s’), e.g., solid features disposed on the inner surface, in the presence of the contact liquid CL (subscript ‘e’).

It may be advantageous to apply a slippery coating to a surface with little or no texture. For example, in high shear environments with highly viscous or abrasive liquids, creating a surface with the precise texture and surface chemistry to stably contain an appropriate lubricating liquid and also maintain low #can be difficult and expensive, rendering such texture non-viable from an economic perspective. Furthermore, a texture, however carefully designed, can become exposed to the elements and erode over time in a harsh environment, such as that of a high-shear mixing tank. Implementing a liquid-impregnated surface with sub-optimal texture, or utilizing a texture that has been compromised by environmental conditions, can lead to pinning and diminished performance. By contrast, in some embodiments, a smooth surface with engineered surface chemistry can have fewer durability issues because there are no features to wear down. In short, there may be circumstances where a traditional liquid-impregnated surface with a solid texture is not desirable and where it may be beneficial to apply a liquid to a surface with little or no texture.

On a surface with little to no texture, however, alternative approaches can be taken to ensure the surface remains stable under pressure fluctuations. Specifically, the surface can be designed that (1) maintains a stable layer of liquid beneath the product, and (2) has ϕ that is low enough that product does not become irreversibly pinned to the surface. Without texture to satisfy (1), the solid-liquid combination can be designed such that there remains a thermodynamically stable layer of the lubricant tightly adhered to the surface by van der Waals forces, even under high sheers stresses and pressure fluctuations. For example, a completely stable layer that exhibits no pinning can be achieved by choosing solid-liquid combinations such that cos θ_{os(e),receding}=0 and cos θ_{os(v),receding}=0. In some embodiments, it can be even more desirable (greater stability) with combinations for which cos θ_{os(e),advancing} is also low (e.g. <30° or <20° or <10° or <5° or <2°) and most desirable if cos θ_{os(e),advancing}=0° is also satisfied. This latter condition is equivalent to the requirement that Sₒₛ₍ₑ₎>0, where Sₒₛ₍ₑ₎ is the spreading coefficient of the liquid on the solid in the presence of the contact liquid. In such cases, a wetting lubricant liquid film will never become unstable beneath the product.

In cases where cos θ_{os(e),receding} is non-zero, but still very low (e.g. <30° or <20° or <10° or <5° or <2°), the lubricating layer can remain stable and slippery over most (at least 90%) of the surface, even after significant shear (e.g. from high speed mixing in a tank or flow through a pipe). Thus, there will be some pinning of product. In such cases it is possible to achieve much thinner films (e.g. t<10 μm) that remain slippery even after significant shearing or pressure fluctuations. The above approach can be used to allow the coatings to withstand high speed mixing for several hours. Furthermore, as described herein, without a low enough contact angle (cos θ_{os(e),receding}) a thin film can de-wet the surface beneath the product to expose a higher fraction of the solid beneath and more product will be pinned as a result.

Lubricious surfaces and/or liquid-encapsulated surfaces described herein, include lubricating liquids that are disposed onto a surface or substrate having a chemistry such that the lubricating liquid preferentially wets the surface and maintains lubricity in the presence of a contact liquid. In some embodiments, the lubricating liquid can have a chemistry such that the contact liquid has a high advancing contact angle and an extremely low roll off angle (e.g., a roll off angle of about 1 degree and a contact angle of greater than about 100 degrees). This enables the contact liquid to displace with substantial ease on the liquid-encapsulated surface. Therefore, the liquid-encapsulated surfaces described herein, provide certain significant advantages over conventional super hydrophobic surfaces including: i) a low hysteresis for the product, ii) self-cleaning properties, iii) ability to withstand high drop impact pressure (i.e., are wear resistant), iv) ability to repel a variety of contact liquids, such as semi-solids, slurries, mixtures and/or non-Newtonian fluids, for example, water, edible liquids or formulations (e.g., ketchup, catsup, mustard, mayonnaise, syrup, honey, jelly, etc.), environmental fluids (e.g., sewage, rain water), bodily fluids (e.g., urine, blood, stool), or any other fluid (e.g. lotion, cream, hair gel, toothpaste), v) reduction of ice formation, vi) enhancing condensation, vii) allowing mold release, viii) preventing corrosion, ix) reducing ice or gas hydrate adhesion, x) preventing scaling from salt or mineral deposits, xi) reducing biofouling, and xii) enhancing condensation.

Examples of lubricating liquids, lubricous surfaces, and applications thereof, are described in U.S. Pat. No. 8,574,704, entitled “Liquid-Impregnated Surfaces, Methods of Making, and Devices Incorporating the Same,” issued Nov. 5, 2013, U.S. Pat. No. 8,535,779, entitled “Self-Lubricating Surfaces for Food Packaging and Food Processing Equipment,” issued Sep. 17, 2013, U.S. Application Publication No. US 2015/0076030, entitled “Non-toxic Liquid-Impregnated Surfaces”, published Mar. 19, 2015, and U.S. Patent Publication No. 2015/0079315, entitled “Articles and Methods for Forming Liquid Films on Surfaces, in Devices Incorporating the Same,” filed Sep. 17, 2014, the entire contents of each of which are hereby incorporated by reference herein. Examples of lubricious surfaces and liquid-encapsulated surfaces and methods for making the same are described in International Patent Application No. PCT/US2018/027340, entitled “Durable Lubricious Surfaces,” filed Apr. 12, 2018, the entire contents of which are hereby incorporated by reference herein.

Embodiments of a liquid-encapsulated or liquid-impregnated surfaces, described herein, include articles, systems and methods configured to provide a supply of a lubricating liquid to an inner surface of a container. The liquid-encapsulated surfaces described herein can be used in systems where a batch-wise flow of a liquid is desired, for example, tanks, mixing vessels, transfer tanks, holding tanks, multi-use containers, or any other article or container.

In some embodiments, a system including a lubricious surface (e.g., a liquid-encapsulated surface) can be used to increase the ease of communication of liquids (e.g., viscous liquids) across the same. In some embodiments, the system can include a liquid-encapsulated surface including an inner surface, optionally a surface coating or other member disposed onto the inner surface, and a lubricating liquid disposed onto the inner surface and/or a surface of the surface coating. In some embodiments, the inner surface of the container or the surface of the surface coating can have a chemistry such that the lubricating liquid preferentially wets the surface and maintains lubricity in the presence of a contact liquid. In some embodiments, the lubricating liquid can be substantially immiscible with the contact liquid. In some embodiments, “substantially immiscible,” in the context of the lubricating liquid and the contact liquid can mean that the miscibility or dissolution rate of the lubricating liquid into the contact liquid is slow enough 1) to preserve sufficient thickness of the lubricating liquid to maintain lubricious character of the system, and 2) not to impact the thermodynamically stable wetting states among the contact liquid, the lubricating liquid and the inner surface such that the lubricious character of the system is maintained. In some embodiments, the lubricating liquid can have a thickness of less than about 200 microns and/or a receding contact angle of less than about 25 degrees in the presence of the contact liquid. In some embodiments, the lubricating liquid can have a thickness of less than about 100 microns, or less than about 50 microns, or less than about 20 microns, or less than about 10 microns, or less than about 5 microns, or less than about 2 microns, or less than about 1 micron.

In some embodiments, the lubricating liquid can have a receding contact angle of at least about 0 degrees, at least about 1 degree, at least about 2 degrees, at least about 3 degrees, at least about 4 degrees, at least about 5 degrees, at least about 10 degrees, at least about 15 degrees, at least about 20 degrees, or at least about 25 degrees in the presence of the contact liquid. In some embodiments, the lubricating liquid can have a receding contact angle of no more than about 30 degrees, no more than about 25 degrees, no more than about 20 degrees, no more than about 15 degrees, no more than about 10 degrees, no more than about 5 degrees, no more than about 4 degrees, no more than about 3 degrees, no more than about 2 degrees, or no more than about 1 degree in the presence of the contact liquid. Combinations of the above-referenced ranges of the receding contact angle of the lubricating liquid in the presence of the contact liquid are also possible (e.g., at least about 0 degrees and no more than about 30 degrees or at least about 10 degrees and no more than about 25 degrees), inclusive of all values and ranges therebetween. In some embodiments, the lubricating liquid can have a receding contact angle of about 0 degrees, about 1 degree, about 2 degrees, about 3 degrees, about 4 degrees, about 5 degrees, about 10 degrees, about 15 degrees, about 20 degrees, about 25 degrees, or about 30 degrees.

In some embodiments, the system can include a liquid delivery mechanism configured to transfer the lubricating liquid to the inner surface of the container or the surface coating. In some embodiments, the liquid delivery mechanism can include a spray device configured to communicate lubricating liquid to the inner surface or the surface coating. In some embodiments, the liquid delivery mechanism can include a metering device configured to control the supply of lubricating liquid to the spray device. In some embodiments, the liquid delivery mechanism can include a reservoir or multiple reservoirs configured to contain a supply of lubricating liquids. In some embodiments, the reservoirs can be operably coupled and/or fluidically coupled to the inner surface such that a supply of lubricating liquid can flow to the inner surface (e.g., onto a surface of the surface coating). In some embodiments, the liquid delivery mechanism can include a pumping mechanism configured to transfer lubricating liquid from the reservoirs to the spray device. In some embodiments, the inner surface or the surface of the surface coating can have little or no texture, little or no texture intentionally added, or substantially no texture added. In other words, in some embodiments, the surface of the member can be substantially smooth.

In some embodiments, the inner surface of the container can be a first surface having a first roll off angle with respect to a contact liquid. In some embodiments, a second surface, formed at least in part by the lubricating liquid, has a second roll off angle with respect to the contact liquid less than the first roll off angle.

In some embodiments, the contact liquid can include but is not limited to at least one of a food, cosmetic product, cement, asphalt, tar, ice cream, egg yolk, toothpaste, paint, peanut butter, jelly, jam, mayonnaise, ketchup, mustard, condiment, laundry detergent, consumer product, gasoline, petroleum product, oil, bitumen, biological fluid, blood, plasma, skin-care product, lotion, conditioner, shampoo, skin creams, sunscreen, hair-care product, hair dyes, hair gels, hair cream, and hair lotion.

In some embodiments, a method of forming a liquid-encapsulated surface includes disposing the lubricating liquid onto the inner surface of the container or the surface coating disposed on the inner surface of the container. In some embodiments, the method can include communicating a supply of the lubricating liquid from the reservoir to the spray device, the spray device configured to communicate the lubricating liquid onto the inner surface of the container or the surface coating disposed on the inner surface of the container. In some embodiments, the method can include spraying a fine mist, droplets, discrete portions, globules, or the like of the lubricating liquid onto the inner surface. In some embodiments, the method can include moving the liquid delivery mechanism or one or more components thereof with respect to the inner surface. For example, in some embodiments, the spray device can be moved vertically and/or horizontally with respect to the inner surface as the spray device deposits the droplets or other portions of lubricating liquid onto the inner surface of the container. In some embodiments, the reservoir can be fluidically coupled to the spray device such that lubricating liquid can be communicated therebetween via at least one of the following: capillary action, pressure differential, temperature differential, concentration and/or surface tension gradients, and the like.

As used herein, the term “about” and “approximately” generally mean plus or minus 10% of the value stated, for example about 250 μm would include 225 μm to 275 μm, about 1,000 μm would include 900 μm to 1,100 μm.

As used herein, the term “contact liquid”, “bulk material, and “product” are used interchangeably to refer to a solid or liquid that flows, for example a non-Newtonian fluid, a Bingham fluid, a high viscosity fluid, multiphase complex fluid, or a thixotropic fluid and is in contact with a liquid-encapsulated surface and/or lubricating liquid, unless otherwise stated.

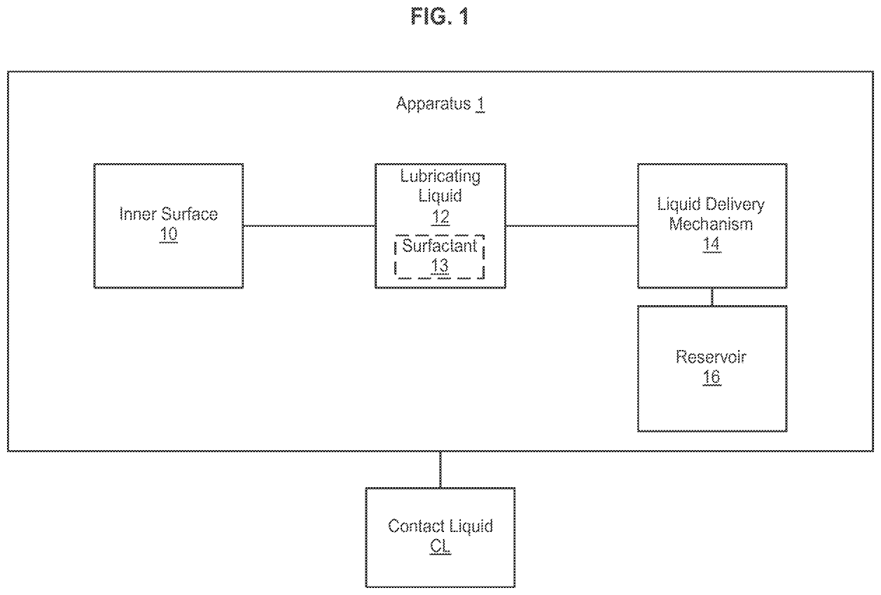

FIG. 1 illustrates a schematic block diagram of an apparatus 1 that includes an inner surface 10, a lubricating liquid 12 disposed on the inner surface 10, and a liquid delivery mechanism 14. The apparatus 1 or a portion thereof can be in contact with a contact liquid CL, such that the contact liquid CL can easily move over the lubricating liquid 12. In other words, the lubricating liquid 12 can create a contact surface and/or modifies surface properties of the inner surface 10 such that the contact liquid CL can more easily flow over the liquid-encapsulated surface when compared to the inner surface 10. The liquid delivery mechanism 14 can be configured to communicate the lubricating liquid 12 to the inner surface 10, as described herein.

The inner surface 10 can be any surface that is configured to contact a contact liquid. For example, in some embodiments, the inner surface 10 can be an inner surface of a container and can have a first roll off angle, for example, a roll off angle of a contact liquid CL (for example, a consumer product, laundry detergent, cough syrup, an edible contact liquid, an industrial liquid, or any other contact liquid described herein) that is undesirable. The inner surface 10 can be a flat surface, for example an inner surface of a prismatic container, a wall, or a contoured surface, for example, a container (e.g. a beverage container), a pipe, a tube, an inner surface, of a circular, oblong, rectangular, elliptical, oval or otherwise contoured container.

In some embodiments, the inner surface 10 can be an inner surface of a container. The container can include any suitable container such as, for example, tubes, bottles, vials, flasks, molds, jars, tubs, cups, caps, glasses, pitchers, barrels, bins, totes, tanks, kegs, tubs, totes, vessels, syringes, tins, pouches, lined boxes, hoses, cylinders, and cans. In such embodiments, the container can be constructed in almost any desirable shape. In some embodiments, the container can be constructed of rigid or flexible materials. Foil-lined or polymer-lined cardboard or paper boxes can also be used to form the container. In some embodiments, the inner surface 10 can include a surface of hoses, piping, conduit, nozzles, syringe needles, dispensing tips, lids, pumps, and other surfaces for containing, transporting, or dispensing the contact liquid CL. In some embodiments, the inner surface 10 can be formed from any suitable material including, for example plastic, glass, metal, alloys, ceramics, coated fibers, any other material, or combinations thereof. Suitable surfaces can include, for example, fluorinated ethylene propylene (FEP), polystyrene, nylon, polypropylene, wax, fluorinated wax, natural waxes, siliconyl waxes, polyethylene terephthalate, poly propylene carbonate, poly imide, polyethylene, polyurethane, graphene, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), perfluoropolyether(PFPE), poly chlorotetrafluoroethylene (PCTFE), polyvinyl alcohol (PVA), polyvinyl acetate (PVAc), polyethyleneglycol (PEG), Polyvinylpyrrolidone (PVP), Polylactic acid (PLA), Acrylonitrile butadiene styrene (ABS), Tecnoflon®, Viton®, FKM, cellulose acetate, poly(acrylic acid), poly(propylene oxide), sorbitol, erythritol, xylitol, lactitol, maltitol, mannitol, and polycarbonate, anodized aluminum, Polydimethylsiloxane (PDMS).

In some embodiments, a surface coating can be disposed on the inner surface 10 or a portion thereof. In some embodiments, the surface coating can include any suitable coating that facilitates the adhesion, pinning, surface tension, and/or any other manner of deposition of the lubricating liquid 12 onto the inner surface 10. In some embodiments, the surface coating can include perfluoroalkanes, organofluorine compounds, fluorocarbons, perfluorocarbons (PFCs), and other suitable compounds. In some embodiments, the surface coating can be disposed onto the inner surface 10 of the container using any suitable method for depositing the surface coating, e.g., in liquid form. In some embodiments, the surface coating can be applied permanently, semi-permanently, or temporarily onto at least a portion of the inner surface 10 of the container. In some embodiments, the surface coating can be applied onto at least a portion of the inner surface 10 of the container and then heated or otherwise treated to solidify the surface coating or to fuse a powder coating to the surface. In some embodiments, after heat treatment and/or other treatment of the surface coating, the inner surface 10 can include the surface coating. In other words, as described herein, the “inner surface 10” can include any native surface or substrate as described herein and can include any surface coating described herein.

In some embodiments, the lubricating liquid 12 can have a viscosity at room temperature of less than about 2,000 cP, for example about 1 cP, about 2 cP, about 3 cP, about 4 cP, about 5 cP, about 10 cP, about 20 cP, about 50 cP, about 100 cP, about 150 cP, about 200 cP, about 300 cP, about 400 cP, about 500 cP, about 600 cP, about 700 cP, about 800 cP, about 900 cP, about 1,000 cP, about 1,500 cP, or about 2,000 cP, inclusive of all ranges and values therebetween. In some embodiments, the lubricating liquid 12 can have viscosity at room temperature of less than about 1 cP, for example, about 0.1 cP, 0.2 cP, 0.3 cP, 0.4 cP, 0.5 cP, 0.6 cP, 0.7 cP, 0.8 cP, 0.9 cP, or about 0.99 cP, inclusive of all ranges and values therebetween. In some embodiments, the lubricating liquid 12 can have a viscosity at room temperature of greater than about 1 cP, greater than about 2 cP, greater than about 3 cP, greater than about 4 cP, greater than about 5 cP, greater than about 10 cP, greater than about 20 cP, greater than about 50 cP, greater than about 100 cP, greater than about 150 cP, greater than about 200 cP, greater than about 300 cP, greater than about 400 cP, greater than about 500 cP, greater than about 600 cP, greater than about 700 cP, greater than about 800 cP, greater than about 900 cP, greater than about 1,000 cP, or greater than about 1,500 cP. In some embodiments, the lubricating liquid 12 can have a viscosity at room temperature of no more than about 2,000 cP, no more than about 1,500 cP, no more than about 1,000 cP, no more than about 900 cP, no more than about 800 cP, no more than about 700 cP, no more than about 600 cP, no more than about 500 cP, no more than about 400 cP, no more than about 300 cP, no more than about 200 cP, no more than about 150 cP, no more than about 100 cP, no more than about 50 cP, no more than about 20 cP, no more than about 10 cP, no more than about 5 cP, no more than about 4 cP, no more than about 3 cP, no more than about 2 cP. Combinations of the above-referenced ranges of the viscosity of the lubricating liquid 12 are also possible (e.g., at least about 1 cP and no more than about 2,000 cP or at least about 10 cP and no more than about 100 cP), inclusive of all ranges and values therebetween.

In some embodiments, the lubricating liquid 12 can have a kinematic viscosity at room temperature of between about 1 cSt and about 2,000 cSt, between about 1 cSt and about 500 cSt, between about 1 cSt and about 200 cSt, between about 1 cSt and about 100 cSt, between about 1 cSt and about 50 cSt, between about 1 cSt and about 20 cSt, between about 1 cSt and about 5 cSt, between about 5 cSt and about 2,000 cSt, between about 5 cSt and about 500 cSt, between about 5 cSt and about 200 cSt, between about 5 cSt and about 100 cSt, between about 5 cSt and about 50 cSt, between about 5 cSt and about 20 cSt, between about 20 cSt and about 2,000 cSt, between about 20 cSt and about 500 cSt, between about 20 cSt and about 200 cSt, between about 20 cSt and about 100 cSt, between about 20 cSt and about 50 cSt, between about 50 cSt and about 2,000 cSt, between about 50 cSt and about 500 cSt, between about 50 cSt and about 200 cSt, between about 50 cSt and about 100 cSt, between about 100 cSt and about 2,000 cSt, between about 100 cSt and about 500 cSt, between about 100 cSt and about 200 cSt, between about 10 cSt and about 400 cSt, between about 20 cSt and about 375 cSt, between about 30 cSt and about 350 cSt, between about 40 cSt and about 325 cSt, between about 50 cSt and about 300 cSt, between about 75 cSt and about 275 cSt, between about 100 cSt and about 250 cSt, between about 125 cSt and about 225 cSt, between about 150 cSt and about 200 cSt, between about 10 cSt and about 375 cSt, between about 10 cSt and about 350 cSt, between about 10 cSt and about 325 cSt, between about 10 cSt and about 300 cSt, between about 10 cSt and about 275 cSt, between about 10 cSt and about 250 cSt, between about 10 cSt and about 225 cSt, between about 10 cSt and about 200 cSt, between about 10 cSt and about 175 cSt, between about 10 cSt and about 150 cSt, between about 10 cSt and about 125 cSt, between about 10 cSt and about 100 cSt, between about 10 cSt and about 75 cSt, between about 10 cSt and about 50 cSt, between about 10 cSt and about 40 cSt, between about 10 cSt and about 30 cSt, between about 10 cSt and about 20 cSt, between about 20 cSt and about 400 cSt, between about 30 cSt and about 400 cSt, between about 40 cSt and about 400 cSt, between about 50 cSt and about 400 cSt, between about 75 cSt and about 400 cSt, between about 100 cSt and about 400 cSt, between about 150 cSt and about 400 cSt, between about 200 cSt and about 400 cSt, or between about 300 cSt and about 400 cSt, inclusive of all values and ranges therebetween. In some embodiments, the lubricating liquid 12 can have a kinematic viscosity of greater than about 10 cSt, 20 cSt, 30 cSt, 40 cSt, 50 cSt, 75 cSt, 100 cSt, 150 cSt, 200 cSt, 300 cSt, or 400 cSt, inclusive of all values and ranges therebetween. In some embodiments, the lubricating liquid 12 can have a kinematic viscosity of less than about 2,000 cSt, 1,000 cSt, 500 cSt, 400 cSt, 300 cSt, 200 cSt, 150 cSt, 100 cSt, 75 cSt, 50 cSt, 40 cSt, 30 cSt, 20 cSt, or 10 cSt, inclusive of all values and ranges therebetween.

The lubricating liquid 12 may be disposed onto the inner surface 10 using any suitable means. For example, the lubricating liquid 12 can be sprayed (e.g., air spray, thermal spray, plasma spray), brushed, or otherwise disposed onto the inner surface 10. In some embodiments, the lubricating liquid 12 can be applied to the inner surface 10 by filling or partially filling the container with the lubricating liquid 12 and then draining or partially draining the lubricating liquid 12 from the container. In some embodiments, the excess lubricating liquid 12 can be removed by adding a wash liquid (e.g., water, surfactants, acids, bases, solvents, etc.), or a heated wash liquid to the container to collect or extract the excess liquid from the container or flowing the wash liquids over the surface of the container. In some embodiments, the lubricating liquid 12 is applied by depositing a solution with the lubricating liquid and one or more volatile liquids (e.g., via any of the previously described methods) and evaporating away the one or more volatile liquids. In some embodiments, the solid materials may be removed in a wash process, and reapplied after the wash process.

In some embodiments, the lubricating liquid 12 can have an average thickness on the inner surface 10 of at least about 5 μm, at least about 6 μm, at least about 7 μm, at least about 8 μm, at least about 9 μm, at least about 10 μm, at least about 15 μm, at least about 20 μm, at least about 25 μm, at least about 30 μm, at least about 35 μm, at least about 40 μm, at least about 45 μm, at least about 50 μm, at least about 55 μm, at least about 60 μm, at least about 65 μm, or at least about 70 μm. In some embodiments, the lubricating liquid 12 can have an average thickness on the inner surface 10 of no more than about 75 μm, no more than about 70 μm, no more than about 65 μm, no more than about 60 μm, no more than about 55 μm, no more than about 50 μm, no more than about 40 μm, no more than about 35 μm, no more than about 30 μm, no more than about 25 μm, no more than about 20 μm, no more than about 15 μm, no more than about 10 μm, no more than about 9 μm, no more than about 8 μm, no more than about 7 μm, or no more than about 6 μm. Combinations of the above-referenced average thickness values for the lubricating liquid 12 on the inner surface 10 are also possible (e.g., at least about 5 μm and no more than about 75 μm or at least about 10 μm and no more than about 30 μm), inclusive of all values and ranges therebetween. In some embodiments, the lubricating liquid 12 can have an average thickness on the inner surface 10 of about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, or about 75 μm.

In some embodiments, the lubricating liquid 12 can include silicone oils, dimethiconol, dimethicone fluids, fisheye remover/eliminator, KE215-HP, Transtar 6737, Eastwood fish eye eliminator, a polydimethylsiloxane, a fluorosurfactant in combination with a polar liquid such as Dupont Capstone Fluorosurfactant FS-22, FS-30, FS-31, and FS-34, a fluorosilicone such as DOW Corning® FS 1265 fluid, siltech fluorosil, liquids that are emulsions such as a mineral oil-PFPE emulsion, PFPE-PEG emulsion, etc., a perfluorocarbon liquid, fluorinated vacuum oil, halogenated vacuum oil, greases, lubricants, (such as Krytox 1506 or Fromblin 06/6), a fluorinated coolant (e.g., perfluoro-tripentylamine sold as FC-70, manufactured by 3M), a high temperature heat transfer fluid (e.g. Galden HT, Novec fluids, etc.), an ionic liquid, a fluorinated ionic liquid that is immiscible with water, a silicone oil comprising PDMS, a fluorinated silicone oil such as, for example polyfluorosiloxane, or polyorganosiloxanes, a liquid metal, a synthetic oil, a vegetable oil, derivative of a vegetable oil, a mono- di- or triglyceride, an electro-rheological fluid, a magneto-rheological fluid, a ferro-fluid, a dielectric liquid, a hydrocarbon liquid such as mineral oil, polyalphaolefins (PAO), fluorinated glycine, fluorinated ethers, or other synthetic hydrocarbon co-oligomers, a fluorocarbon liquid, for example, polyphenyl ether (PPE), perfluoropolyether (PFPE), or perfluoroalkanes, a refrigerant, a vacuum oil, a phase-change material, a semi-liquid, polyalkylene glycol, esters of saturated fatty and dibasic acids, polyurea, grease, synovial fluid, bodily fluid, any other aqueous fluid, any other fluid, any other lubricating liquid described herein, any other suitable fluid, or any combination thereof. In some embodiments, the lubricating liquid 12 can include an ionic liquid. Such ionic lubricating liquids can include, for example, tetrachloroethylene (perchloroethylene), phenyl isothiocyanate (phenyl mustard oil), bromo benzene, iodobenzene, obromotoluene, alpha-chloronaphthalene, alpha-bromonaphthalene, acetylene tetrabromide, 1-butyl-3-methylimidazolium bis(trifluoromethylsulfonyl) imide (BMim), tribromohydrin (1,2,3-tribromopropane), tetradecane, cyclohexane, ethylene dibromide, carbon disulfide, bromoform, methylene iodide (diiodomethane), stanolax, Squibb's liquid petrolatum, p-bromotoluene, monobromobenzene, perchloroethylene, MCT oil (medium chain triglycerides), carbon disulfide, phenyl mustard oil, monoiodobenzene, triacetin, triglyceride of citric acid, alpha-monochloro-naphthalene, acetylene tetrabromide, aniline, butyl alcohol, isoamyl alcohol, n-heptyl alcohol, cresol, oleic acid, linoleic acid, amyl phthalate, cosmetic solvents composed substantially or entirely of hydrocarbons, (e.g., isododecane, isohexadecane, dodecane, tetradecane, 2,2,4,6,6-Pentamehylheptane, 2,2,4,4,6,8,8-Heptamethylnonane, squalene, and squalane, hemisqualane, isoparaffin), or any other ionic liquid and any combination thereof.

In some embodiments, the lubricating liquid 12 can include a surfactant 13. In some embodiments, the surfactant 13 can include, for example, ammonium lauryl sulfate, sodium lauryl sulfate, sodium lauryl ether sulfate, sodium myreth sulfate, dioctyl sodium sulfosuccinate, perfluorooctanesulfonate, perfluorobutanesulfonate, alkyl-aryl ether phosphates, alkyl ether phosphates, sodium stearate, sodium lauroyl sarcosinate, perfluorononanoate, perfluorooctanoate, octenidine dihydrochloride, cetrimonium bromide (CTAB), cetylpyridinium chloride (CPC), benzalkonium chloride (BAC), benzethonium chloride (BZT), dimethyldioctadecylammonium chloride, dioctadecyldimethylammonium bromide (DODAB), cocamidopropyl hydroxysultaine, cocamidopropyl betaine, phospholipids phosphatidylserine, phosphatidylethanolamine, phosphatidylcholine, sphingomyelins, narrow-range ethoxylate, octaethylene glycol monododecyl ether, pentaethylene glycol monododecyl ether, nonoxynols, Triton X-100, polyethoxylated tallow amine, cocamide monoethanolamine, cocamide diethanolamine, poloxamers, glycerol monostearate, glycerol monolaurate, sorbitan monolaurate, sorbitan monostearate, sorbitan tristearate, sorbitan oleate, Tween 20, Tween 40, Tween 60, Tween 80, alkyl polyglycoside, decyl glucoside, lauryl glucoside, octyl glucoside, lauryldimethylamine oxide, PEG/PPG-18/18 dimethicone, PEG-12 dimethicone, PEG-10 dimethicone, cetyl PEG/PPG-10/1 dimethicone, polyglycerin-3 diisostearate, lauryl PEG/PPG-18/18 methicone, polyglyceryl-4 oleate, PEG-8 propylene glycol cocoate, PEG-9 dimethicone, PEG/PPG-10/15 dimethicone, alkyl polyether polydimethylsiloxane, acrylates/ethylhexyl acrylate copolymer, PEG/PPG-19/19 dimethicone, bis-PEG/PPG-14/14 dimethicone, hexyl Laurate, polyglyceryl-4 isostearate, potassium stearate, PEG/PPG-20/15 dimethicone, cetyl PEG/PPG-10/1 dimethicone, polyglyceryl-2-isostearate, PEG-3 dimethicone, PEG-9 methyl ether dimethicone, lauryl PEG-10 methyl ether dimethicone, caprylyl dimethicone ethoxy glucoside, PEG/PPG-30/10 dimethicone, glyceryl stearate, PEG-100 stearate, PEG/PPG-20/22 butyl ether dimethicone, polyglyceryl-3 disiloxane dimethicone, polyglyceryl-3 polyricinoleate, STEARETH-2, Sorbeth-20, glyceryl stearate, glyceryl caprylate, behenyl behenate, glyceryl hydroxystearate, stearyl behenate, stearyl stearate, sorbitan olivate, sorbitan sesquioleate, dicocoyl pentaerythrityl distearyl citrate, PEG-7 hydrogenated castor oil, polyoxyethylene lauryl ethen caprylate, polyglyceryl-2 diisostearate, polyglyceryl-3 oleate, stearalkonium bentonite, Quaternium-90 bentonite, cetyl alcohol, stearyl alcohol, lanolin alcohol, Stealth-2, polyglyceryl-2 sesquiisostearate, polyglyceryl-2 stearate, ethylhexylstearate, polyglyceryl-3-diisostearate, PEG-40 sorbitan peroleate, lauryl PEG-10 tris(trimethylsiloxy)silylethyl dimethicone, polyglyceryl-2 sesquioleate, polyglyceryl-6 Polyricinoleate, polyglyceryl-3 diisostearate, disteardimonium Hectorite, dimethicone PEG-8 lanolate, Oleth-10, Oleth-2, Oleth-3, Cocamide DEA, Cocamide MEA, PEG-30 dipolyhydroxystearate, polysorbate 28, Bis-(Glyceryl/Lauryl) Glyceryl Lauryl Dimethicone, Cetyl PEG/PPG-10/1 Dimethicone, Bis-PEG/PPG-14/14 Dimethicone, Polyglyceryl-3 triolivate, Polyglyceryl-6 Polyhydroxystearate, Polyglyceryl-3-Sorbityl Linseedate, Ceteareth-6, Ceteareth-25, Lauryl PEG-9 Polydimethylsiloxyethyl Dimethicone, Glyceryl dilaurate, PEG-150 Stearate, Isostearyl Diglyceryl Succinate, Polyglyceryl-2 Oleate, Sorbitan Palmitate, Sorbitan Trioleate, Glyceryl monostearate, PEG-80 Sorbitan Oleate, Cetyl PEG/PPG-7/3 Dimethicone, Sorbitan Monopalmitate, Sorbitan Monooleate, Polyglyceryl-2 Isostearate, Polyglyceryl-2 Triisostearate, Sorbitan Isostearate, Sorbitan Stearate, Laureth-9, Polysorbate 81, Polyglyceryl-10 Decaoleate, Polyglyceryl-6 Distearate, PEG-20 Methyl Glucose Sesquistearate, Methyl glucose dioleate, Methyl Glucose Sesquistearate, Polyglyceryl-3 Pentaolivate, Oleamide DEA, Polyglyceryl-10 Pentaoleate, Methoxy PEG-22/Dodecyl Glycol Copolymer, PEG-22/Dodecyl Glycol Copolymer, PEG-45/Dodecyl Glycol Copolymer, Triisostearin, Calcium Stearoyl Lactylate, Steareth-21, Lauryl PEG-8 Dimethicone, Polysorbate 80, Polysorbate 20, Polyperfluoroethoxymethoxy Difluoromethyl Distearamide, Apricot Kernel Oil Polyglyceryl-4 Esters, Quaternium-82, Lecithin, Polyglyceryl-2 sesquicaprylate, Propylene Glycol Hydroxystearate, C12-C18 Diglycerides, PEG-3 C12-18 alcohol, Liquid polysiloxane polyalkyl polyether block copolymer, Cholesterol, Polyglycerol-10 mono/dioleate, Ceteareth-4, Trideceth-12, Oleylbis(2-hydroxyethyl)methylammonium chloride, PPG-2 Isoceteth-20 Acetate, Glycereth-7 Citrate, PEG-20 Glyceryl Stearate, Cetoleth-10, Cetoleth-5, Ammonium Acryloyldimethyltaurate/Beheneth-25 Methacrylate Crosspolymer, Polypropylene Terephthalate, Acrylates/Palmeth-25 Acrylate Copolymer, Sorbitan Oleate Decylglucoside Crosspolymer, Ceteth-10, Ceteth-2, Ceteth-20, Polyglyceryl-4 Laurate/Succinate, PEG-30 Lanolin, Sodium Acrylate/Sodium Acryloyldimethyl Taurate Copolymer, Cetyl Phosphate, Potassium Cetyl Phosphate, Polyglyceryl-5 laurate, Ethanol, 2, 2′-(2-heptadecenyl-4(5H)oxazoline), Polyglyceryl-10 Laurate, Laneth-15, PEG-75 Meadowfoam Oil, Laureth-23, Oleth-20, Oleth-23, Laureth-7, Steareth-20, Bis-PEG/PPG-16/16 PEG/PPG-16/16 Dimethicone, Bis-PEG/PPG-20/5 PEG/PPG-20/5 Dimethicone, Methoxy PEG/PPG-25/4 Dimethicone, Sorbitan mono palmitate, Sorbitan mono stearate, Polyglyceryl-4 Oleyl Ether, PEG-8 beeswax, PEG-9 Laurate, PEG-14 Oleate, POE-9 Mono Oleate, PEG-8 dilaurate, Laureth-4 phosphate, Oleth-5 Phosphate, Trilaureth-4 phosphate, Ceteareth-100, Ceteareth-12, Ceteareth-20, Ceteareth-25, Ceteareth-30, Ceteth-10 phosphate, Cetyl phosphate, Polyurethane-62, Trideceth-6, Polyoxyethylene alkyl ether, Didecyldimethylammonium chloride, Sucrose Stearate, Sucrose Distearate, Sucrose Laurate, Sucrose Dilaurate, Sucrose Trilaurate, PEG-150 Distearate, C12-C18 Diglycerides, PEG-3 Lauryl Ether, PEG-10 C12-C18 alcohol, PEG-5 C12-C18 alcohol, PEG-100 Almond Glycerides, Cetoleth-20. In some embodiments the liquid may be a mixture of any of the above liquids and surfactants. In some embodiments that mixture can be an emulsion or suspension.

In some embodiments, the surfactant 13 can be substantially immiscible to the primary components of the lubricating liquid 12 and can have affinity to the contact liquid CL over the primary components of the lubricating liquid 12, thereby forming a barrier that prevents one or more components of the contact liquid CL from diffusing into the lubricating liquid 12. Said another way, the surfactant 13 can be substantially immiscible with the lubricating liquid 12 and can be at least partially miscible with the contact liquid CL, such that the surfactant 13 forms a barrier at the interface between the lubricating liquid 12 and the contact liquid CL that prevents one or more components of the contact liquid CL from diffusing into the lubricating liquid 12. In some embodiments, “substantially immiscible” and “partially miscible,” in the context of the contact liquid CL, the lubricating liquid 12, and the surfactant 13, can mean that the dissolution rate of the surfactant 13 into the contact liquid 12 is slow enough not to impact the thermodynamically stable wetting states among the contact liquid CL, the lubricating liquid 12, and the inner surface 10 such that the lubricious character of the system is maintained and such that the contact liquid CL maintains a desired quality level.

In some embodiments, the surfactant 13 can include a compound with an amphiphilic molecule. In some embodiments, the surfactant 13 can include both hydrophilic and lipophilic properties. In some embodiments, the surfactant 13 can have a molecule that has an affinity for the lubricating liquid 12 on a first side of the molecule and an affinity for the contact liquid CL on a second side of the molecule. In some embodiments, the amphiphilic character of the surfactant 13 can contribute to the formation of the barrier that prevents one or more components of the contact liquid CL from diffusing into the lubricating liquid 12. In some embodiments, the surfactant 13 can include micelles, detergents, soaps, and/or lipoproteins. In some embodiments, the surfactant 13 can be more hydrophilic than hydrophobic. In some embodiments, the surfactant 13 can be more hydrophobic than hydrophilic.

In some embodiments, the liquid delivery mechanism 14 can be configured to transfer the lubricating liquid 12 onto the inner surface 10 of the container. In some embodiments, the liquid delivery mechanism 14 can include the spray device configured to communicate the lubricating liquid 12 to the inner surface 10. In some embodiments, the liquid delivery mechanism 14 can include a metering device configured to control the supply of the lubricating liquid 12 to the spray device. In some embodiments, the liquid delivery mechanism 14 can include a reservoir 16 configured to contain a supply of the lubricating liquid 12. In some embodiments, the liquid delivery mechanism 14 can include multiple reservoirs 16 configured to contain a supply of the multiple lubricating liquids 12. In some embodiments, the reservoir 16 can be operably coupled and/or fluidically coupled to the inner surface 10 such that a supply of the lubricating liquid 12 can be communicated from the reservoir 16 to the liquid delivery mechanism 14 and then onto the inner surface 10. In some embodiments, the reservoir 16 containing the supply of the lubricating liquid 12 can have a higher pressure than the pressure within the liquid delivery mechanism 14 or a component thereof such that the supply of the lubricating liquid 12 is forced into the liquid delivery mechanism 14 by the pressure differential. In some embodiments, the liquid delivery mechanism 14 can include a pumping mechanism configured to transfer the lubricating liquid 12 from the reservoir 16 to the liquid delivery mechanism 14. In some embodiments, the liquid delivery mechanism 14 can include the spray device configured to communicate the lubricating liquid 12 onto the inner surface 10. In some embodiments, the spray device can include a centrifugal sprayer, an electrostatic sprayer, an atomizer, an ultrasonic atomizer, an ultrasonic sprayer, an air sprayer, an airless sprayer, a hydraulic sprayer, pump sprayer, or the like. In some embodiments the system can include a spray nozzle and the spray nozzle could include flat fan nozzles with convex or even distributions, extended range flat fan nozzles, standard flat fan nozzles, drift guard flat fan nozzles, twin nozzles, wide angle full core nozzles, flood nozzles, rainbow hollow cone nozzles, full cone nozzles with flat or even distributions, axial cone nozzles, spiral cone nozzles, tangential cone nozzles, or hollow cone nozzles. In some embodiments the spray system can be portable and can be used to replenish liquid for multiple tanks.

In some embodiments, the liquid delivery mechanism 14 can be used to deposit discrete portions of the lubricating liquid 12 onto the inner surface 10 of the container prior to charging the contact liquid CL into the inner volume of the container. In some embodiments, the volume ratio or mass ratio of lubricating liquid 12 to container capacity can be between about 1×10⁻⁶ to about 9×10⁻³, between about 2×10⁻⁶ to about 8×10⁻³, between about 3×10⁻⁶ to about 7×10⁻³, between about 4×10⁻⁶ to about 9×10⁻³, between about 6×10⁻⁶ to about 9×10⁻³, between about 1×10⁻⁵ to about 9×10⁻⁴, between about 1×10⁻⁶ to about 9×10⁻⁴, between about 1×10⁻⁷ to about 9×10⁻³, between about 1×10⁻⁵ to about 9×10⁻⁴, between about 1×10⁻⁵ to about 1×10⁻⁶, between about 5×10⁻⁶ to about 5×10⁻⁵, between about 7×10⁻⁵ to about 9×10⁻⁴, or between about 7×10⁻⁶ to about 7×10⁻⁵, between about 1×10⁻⁶ to about 1×10⁻⁴, between about 1×10⁻⁵ to about 5×10⁻⁴, between about 1×10⁻⁶ to about 1×10⁻⁵, between about 1×10⁻⁶ to about 5×10⁻⁴, greater than about 1×10⁻⁶, greater than about 1×10⁻⁵, greater than about 1×10⁻⁴, greater than about 5×10⁻⁴, greater than about 1×10⁻³, less than about 1×10⁻³, less than about 5×10⁻⁴, less than about 1×10⁻⁴, less than about 1×10⁻⁵, less than about 1×10⁻⁶, inclusive of all values and ranges therebetween. In some embodiments, the volume ratio or mass percentage of lubricating liquid 12 to container capacity can be between about 0.0001% to about 0.01%, between about 0.001% and about 0.05%, between about 0.0001% to about 0.001%, between about 0.0001% and about 0.05%, greater than about 0.0001%, greater than about 0.001%, greater than about 0.01%, greater than about 0.05%, greater than about 0.1%, less than about 0.1%, less than about 0.05%, less than about 0.01%, less than about 0.001%, or less than about 0.0001%, inclusive of all values and ranges therebetween.

In some embodiments, the average volume of lubricating liquid 12 per unit surface area applied to the inner surface 10 can be at least about 5 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, at least about 350 μm, at least about 400 μm, or at least about 450 μm. In some embodiments, the average volume of lubricating liquid 12 per unit surface area applied to the inner surface 10 can be no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, or no more than about 10 μm. Combinations of the above-referenced ranges for the average volume of lubricating liquid 12 per unit surface area applied to the inner surface are also possible (e.g., at least about 5 μm and no more than about 500 μm or at least about 20 μm and no more than about 100 μm), inclusive of all values and ranges therebetween. In some embodiments, the average volume of lubricating liquid 12 per unit surface area applied to the inner surface 10 can be about 5 μm, about 10 μm, about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, or about 500 μm.

In some embodiments, the lubricating liquid 12 is disposed on the surface of the inner surface 10 such that discrete portions of the lubricating liquid 12 are dispersed, substantially dispersed, or partially dispersed across the inner surface 10. In some embodiments, the discrete portions of the lubricating liquid 12 can be a fine mist, droplets, discrete portions, globules, or any other suitable form factor. In some embodiments, the discrete portions of the lubricating liquid 12 can be spray-deposited or otherwise deposited onto the inner surface 10 such that the discrete portions of the lubricating liquid 12 become pinned onto the inner surface 10. In some embodiments, in order for discrete droplets to be stably pinned to the surface, the droplets have nonzero contact angle in the air (θ_{os(v),receding}>0 or θ_{os(v),advancing}>0). In some embodiments, in order for discrete droplets to be stably pinned to the surface, the droplets have nonzero contact angle on the surface.

In some embodiments, the liquid delivery mechanism 14, one or more components of the liquid delivery mechanism 14, and/or the reservoir 16 can be moved with respect to the inner surface 10 during deposition of the lubricating liquid 12 onto the inner surface 10. In some embodiments, the movement of the liquid delivery mechanism 14, one or more components of the liquid delivery mechanism 14, and/or the reservoir 16 can be vertical, horizontal, rotational, or a change in distance from the inner surface 10. In some embodiments, the liquid delivery mechanism 14 can include an arm or other actuating device positioned within, partially within, or above an orifice of the inner volume of the container. In some embodiments, the arm or other actuating device can be actuated or caused to be actuated during spray deposition of the lubricating liquid 12 onto the inner surface 10. In some embodiments, the arm or other actuating device can be actuated at least once to move the liquid delivery mechanism 14, one or more components of the liquid delivery mechanism 14, and/or the reservoir 16 vertically within the inner volume of the container. In some embodiments, the arm or other actuating device can be actuated at least once to move the liquid delivery mechanism 14, one or more components of the liquid delivery mechanism 14, and/or the reservoir 16 rotationally within the inner volume of the container. In some embodiments, the arm or other actuating device can be actuated at least once to move the liquid delivery mechanism 14, one or more components of the liquid delivery mechanism 14, and/or the reservoir 16 closer to or further away from the inner volume of the container. In some embodiments, the liquid delivery mechanism 14 or a component thereof, e.g., the spray device, can be configured to spray the lubricating liquid 12 fully 3600 with respect to the spray device, thereby forming a uniform or substantially uniform distribution of droplets of lubricating liquid 12 on the inner surface 10. In some embodiments, as the spray device is delivering a uniform or substantially uniform distribution of droplets of lubricating liquid 12 on the inner surface 10, the spray device can be moved vertically at a constant or substantially constant rate. In some embodiments, moving the spray device vertically during spraying of the lubricating liquid 12 can result in a distribution of droplets of lubricating liquid 12 on the inner surface that is uniform or substantially uniform at different vertical levels of the container, or at a varying rate to cause a varying number of droplets per unit area at different levels in the tank. As described herein, a single movement of the spray device vertically in the container during deposition of droplets of the lubricating liquid 12 onto the inner surface 10 constitutes a single pass. In some embodiments, the desired quantity of lubricating liquid 12 can be communicated onto the inner surface 10 of the container using a single pass of the spray device or the like. In some embodiments, the desired quantity of lubricating liquid 12 can be communicated onto the inner surface 10 of the container after about one pass, two passes, about three passes, about four passes, about five passes, about six passes, about seven passes, about eight passes, about nine passes, about 10 passes, about 11 passes, about 12 passes, about 13 passes, about 14 passes, about 15 passes, about 16 passes, about 17 passes, about 18 passes, about 19 passes, about 20 passes, about 21 passes, about 22 passes, about 23 passes, about 24 passes, about 25 passes, about 26 passes, about 27 passes, about 28 passes, about 29 passes, about 30 passes, about 31 passes, about 32 passes, about 33 passes, about 34 passes, about 35 passes, about 36 passes, about 37 passes, about 38 passes, about 39 passes, about 40 passes, about 41 passes, about 42 passes, about 43 passes, about 44 passes, about 45 passes, about 46 passes, about 47 passes, about 48 passes, about 49 passes, about 50 passes, more than about 50 passes, or more than about 100 passes, inclusive of all values and ranges therebetween. In some embodiments, the desired quantity of lubricating liquid 12 can be communicated onto the inner surface 10 of the container in less than about 100 passes, about 50 passes, about 49 passes, about 48 passes, about 47 passes, about 46 passes, about 45 passes, about 44 passes about 43 passes, about 42 passes, about 41 passes, about 40 passes, about 39 passes, about 38 passes, about 37 passes, about 36 passes, about 35 passes, about 34 passes, about 33 passes, about 32 passes, about 31 passes, about 30 passes, about 29 passes, about 28 passes, about 27 passes, about 26 passes, about 25 passes, about 24 passes, about 23 passes, about 22 passes, about 21 passes, about 20 passes, about 19 passes, about 18 passes, about 17 passes, about 16 passes, about 15 passes, about 14 passes, about 13 passes, about 12 passes, about 11 passes, about 10 passes, about nine passes, about eight passes, about seven passes, about six passes, about five passes, about four passes, about three passes, about two passes or in one pass, inclusive of all values or ranges therebetween.

The number of passes after which the desired quantity of lubricating liquid 12 is disposed onto the inner surface 10 of the container can also be a function of the speed at which the spray device is moved vertically within the container during deposition of droplets of the lubricating liquid 12 onto the inner surface 10, e.g., during a single pass. In other words, holding the spray rate constant, if the spray device is moved vertically at a faster rate within the container, then the desired quantity of lubricating liquid 12 may be disposed onto the inner surface 10 after a higher number of passes. However, holding the spray rate constant, if the rate at which the spray device is moved vertically at a slower rate within the container, then the desired quantity of lubricating liquid 12 may be disposed onto the inner surface 10 after a lower number of passes, e.g., as few as one pass.

In some embodiments, the discrete portions can have an average dimension of between about 10 μm and about 150 μm, about 15 μm and about 145 μm, about 20 μm and about 140 μm, about 25 μm and about 135 μm, about 30 μm and about 130 μm, about 35 μm and about 125 μm, about 40 μm and about 120 μm, about 45 μm and about 115 μm, about 50 μm and about 110 μm, about 55 μm and about 105 μm, about 60 μm and about 100 μm, about 65 μm and about 95 μm, about 70 μm and about 90 μm, about 75 μm and about 85 μm, about 70 μm and about 80 μm, about 10 μm and about 145 μm, about 10 μm and about 140 μm, about 10 μm and about 135 μm, about 10 μm and about 130 μm, about 10 μm and about 125 μm, about 10 μm and about 120 μm, about 10 μm and about 115 μm, about 10 μm and about 110 μm, about 10 μm and about 105 μm, about 10 μm and about 100 μm, about 10 μm and about 95 μm, about 10 μm and about 90 μm, about 10 μm and about 85 μm, about 10 μm and about 80 μm, about 10 μm and about 75 μm, about 10 μm and about 70 μm, about 10 μm and about 65 μm, about 10 μm and about 60 μm, about 10 μm and about 55 μm, about 10 μm and about 50 μm, about 10 μm and about 45 μm, about 10 μm and about 40 μm, about 10 μm and about 35 μm, about 10 μm and about 30 μm, about 10 μm and about 25 μm, about 10 μm and about 20 μm, about 10 μm and about 15 μm, about 15 μm and about 150 μm, about 20 μm and about 150 μm, about 25 μm and about 150 μm, about 30 μm and about 150 μm, about 35 μm and about 150 μm, about 40 μm and about 150 μm, about 45 μm and about 150 μm, about 50 μm and about 150 μm, about 55 μm and about 150 μm, about 60 μm and about 150 μm, about 65 μm and about 150 μm, about 70 μm and about 150 μm, about 75 μm and about 150 μm, about 80 μm and about 150 μm, about 85 μm and about 150 μm, about 90 μm and about 150 μm, about 95 μm and about 150 μm, about 100 μm and about 150 μm, about 105 μm and about 150 μm, about 110 μm and about 150 μm, about 115 μm and about 150 μm, about 120 μm and about 150 μm, about 125 μm and about 150 μm, about 130 μm and about 150 μm, about 135 μm and about 150 μm, about 140 μm and about 150 μm, or about 145 μm and about 150 μm, inclusive of all values and ranges therebetween. In some embodiments, the discrete portions can have an average dimension of greater than about 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, or 150 μm, inclusive of all values and ranges therebetween. In some embodiments, the discrete portions can have an average dimension of less than about 5 mm, 4 mm, 3 mm, 2 mm, 1 mm, 500 μm, 400 μm, 300 μm, 250 μm, 200 μm, 175 μm, 150 μm, 145 μm, 140 μm, 135 μm, 130 μm, 125 μm, 120 μm, 115 μm, 110 μm, 105 μm, 100 μm, 95 μm, 90 μm, 85 μm, 80 μm, 75 μm, 70 μm, 65 μm, 60 μm, 55 μm, 50 μm, 45 μm, 40 μm, 35 μm, 30 μm, 25 μm, 20 μm, 15 μm, or 10 μm, inclusive of all values and ranges therebetween. As described herein, the “average dimension” of the discrete portions can include the diameter, length, width, height, and/or any other dimensional aspect of the discrete portions of the lubricating liquid 12. In some embodiments, the discrete portions can have an average diameter that is substantially similar to the average height of the discrete portions above the inner surface 10. In some embodiments, the discrete portions can have any polygonal shape, including but not limited to spheres, cubes, cuboids, ellipsoids, cylinders, cones, triangular prisms, hexagonal prisms, icosahedrons, octahedrons, tetrahedrons, dodecahedrons, hexahedrons, any combination thereof, or the like.

In some embodiments, the droplets of lubricating liquid 12 can have an average diameter of at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1000 μm, at least about 2000 μm, or at least about 3000 μm. In some embodiments, the droplets of lubricating liquid 12 can have an average diameter of no more than about 4,000 μm, no more than about 3,000 μm, no more than about 2,000 μm, no more than about 1,000 μm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, or no more than about 50 μm. Combinations of the above-referenced values for average diameter of droplets of lubricating liquid 12 are also possible (e.g., at least about 40 μm and no more than about 4,000 μm or at least about 50 μm and no more than about 1,000 μm), inclusive of all values and ranges therebetween. In some embodiments the droplets of lubricating liquid 12 can have an average diameter of about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1000 μm, about 2000 μm, about 3000 μm, or about 4000 μm.

In some embodiments, the discrete portions of the lubricating liquid 12 can be dispersed across the inner surface 10 or a portion of the inner surface 10 such that an average distance between the edge of each discrete portion and the edge of a nearby discrete portion is similar to the average dimension of the discrete portions. In other words, the distance between neighboring droplets of the lubricating liquid 12 can be similar to or greater than the diameter of each pinned droplet of the lubricating liquid 12. In some embodiments, the average distance between neighboring droplets of the lubricating liquid 12 on the inner surface 10 can be at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, at least about 950 μm, at least about 1 mm, at least about 2 mm, at least about 3 mm, at least about 4 mm, at least about 5 mm, at least about 6 mm, at least about 7 mm, at least about 8 mm, or at least about 9 mm. In some embodiments, the average distance between neighboring droplets of the lubricating liquid 12 on the inner surface can be no more than about 10 mm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 90 μm, no more than about 80 μm, no more than about 70 μm, or no more than about 60 μm.

Combinations of the above-referenced ranges for the average distance between neighboring droplets of the lubricating liquid 12 on the inner surface 10 are also possible (e.g., at least about 50 μm and no more than about 10 mm or at least about 200 μm and no more than about 900 μm), inclusive of all values and ranges therebetween. In some embodiments, the average distance between neighboring droplets of the lubricating liquid 12 on the inner surface 10 can be about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 2 mm, about 3 mm, about 4 mm, about 5 mm, about 6 mm, about 7 mm, about 8 mm, about 9 mm, or about 10 mm.

In some embodiments, when the lubricating liquid 12 is disposed on the inner surface 10 of the container, the pinned droplets of lubricating liquid 12 can remain pinned to the inner surface 10 for a sufficiently long time such that the contact liquid CL can be charged into the inner volume of the container. In some embodiments, the lubricating liquid 12 can be non-volatile or have very low volatility such that the lubricating liquid 12 does not substantially evaporate off the inner surface 10 before the contact liquid CL can be charged into the inner volume of the container. In some embodiments, the lubricating liquid 12 can include a volatile liquid mixed with a low volatility liquid or nonvolatile liquid, such that only the volatile liquid substantially evaporates, leaving behind droplets that are comprised substantially of the low volatility liquid. In some embodiments, the lubricating liquid 12 can be disposed on the inner surface 10 of the container at a first time and the contact liquid CL can be charged into the inner volume of the container at a second time. In some embodiments, the second time can be more than an hour, day, week, or longer after the first time.

Without wishing to be bound by any particular theory, charging the contact liquid CL into the inner volume of the container can cause or partially cause the dispersion of the discrete portions of lubricating liquid 12 across the inner surface 10 due to an immiscibility of the lubricating liquid 12 and the contact liquid CL. In some embodiments, the contact liquid CL can be filled into the inner volume of the container from a fill port positioned at the bottom of the container. In some embodiments, as the contact liquid CL is charged into the inner volume of the container, a leading edge at the interface between the discrete portions of lubricating liquid 12 and the contact liquid CL can form. In some embodiments, the leading edge of lubricating liquid 12 can be moved up the inner surface 10 of the container as the contact liquid CL is charged into the inner volume of the container. In some embodiments, the leading edge can be formed from the contact liquid CL, the lubricating liquid 12, or some combination thereof.

In some embodiments, the inner surface 10 can have surface characteristics, e.g., surface chemistry, such that the inner surface 10 has a first roll off angle for the contact liquid CL such that at least a portion of the contact liquid CL remains on the inner surface 10 at any angle that is less than the roll-off angle. In some embodiments, the lubricating liquid 12 disposed on the inner surface 10 of the container can be configured to define a liquid-encapsulated surface having a second roll off angle less than the first roll of angle (i.e., the roll of angle of the unmodified inner surface 10). In some embodiments, the lubricating liquid 12, once dispersed across the inner surface 10 of the container, can have advantageous droplet roll-off properties that minimize the accumulation of the contact liquid CL on the inner surface 10 of the container. Without wishing to be bound by any particular theory, in some embodiments, a roll off angle, which is the angle of inclination of the inner surface 10 at which a droplet of contact liquid CL placed on the lubricating liquid 12 coating begins to move, can be less than about 30°, less than about 25°, less than about 20°, less than about 19°, less than about 18°, less than about 17°, less than about 16°, less than about 15°, less than about 10°, or less than about 5°, for a specific volume of contact liquid CL. In some embodiments, the roll off angle can vary with the volume of the contact liquid CL included in the droplet, but for a specific volume of the contact liquid CL, the roll off angle remains substantially the same.

In some embodiments, the composition and method of depositing the lubricating liquid 12 onto the inner surface 10 can be changed or fine-tuned such that when the contact liquid CL is charged into the inner volume of the container, the discrete portions of the lubricating liquid 12 are partially or fully dispersed across the inner surface 10, forming a lubricious surface on the inner surface 10. In some embodiments, the composition of the lubricating liquid 12 and/or the composition of the inner surface 10 or a surface coating thereupon can be changed to increase the lubricity of the lubricious surface formed by the lubricating liquid 12 on the inner surface 10. In some embodiments, the manner and timing in which the lubricating liquid 12 is disposed onto the inner surface 10 can be changed to increase the lubricity of the lubricious surface formed by the lubricating liquid 12 on the inner surface 10. In some embodiments, the size and/or distribution density of discrete portions of the lubricating liquid 12 disposed on the inner surface 10 of the container can be changed to increase the lubricity of the lubricious surface formed by the lubricating liquid 12 on the inner surface 10. The handful of characteristics, compositional attributes, methodological aspects, and other parameters described herein as being changeable such that the lubricity of the lubricious surface can be increased are provided only as a small set of possible parameters and is not intended to limit in any way the parameters that can be changed to affect lubricity. One of skill in the art will understand that other parameters can be changed or fine-tuned in order to achieve the desired lubricity of the lubricious surface with respect to the contact liquid CL.

In some embodiments, charging a desired volume of the contact liquid CL into the inner volume of the container can cause the dispersion of the discrete portions (e.g., droplets) of the lubricating liquid 12 across the inner surface 10. In some embodiments, the dispersed lubricating liquid 12 can form a layer on at least a portion of the inner surface 10 of the container. In some embodiments, if the contact liquid CL is charged into the inner volume of the container from the bottom of the container, the droplets of lubricating liquid 12 can be dispersed as needed to at least the fill line of contact liquid CL and droplets that remain above the fill line and are not dispersed may not affect the lubricity of the portion of the inner surface in contact with the contact liquid CL.

In some embodiments, the thickness of the distributed lubricating liquid 12 can depend on a number of factors, including viscosity of the lubricating liquid 12. Other factors include the price of the lubricating liquid 12. Where expensive or specialty liquids are being used, economic viability may require using less liquid. Another consideration is whether any amount of liquid triggers issues of compatibility with product. Finally, regulations governing the product may impose limitations on the amounts of liquid that can be used. In some embodiments, the distribution of liquid across the surface may not be perfectly uniform, may be uniform across at least some portion of the inner surface 10, may be sufficiently uniform to achieve the desired lubricity without being perfectly uniform, or may be insufficiently uniform to achieve the desired lubricity but may achieve a higher lubricity than the uncoated inner surface 10.

In some embodiments, the layer of lubricating liquid 12 formed from the dispersion of the discrete portions of lubricating liquid 12 across the inner surface 10 can have a thickness of at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 15 μm, at least about 20 μm, at least about 25 μm, at least about 30 μm, at least about 35 μm, at least about 40 μm, at least about 45 μm, at least about 50 μm, at least about 55 μm, at least about 60 μm, at least about 65 μm, at least about 70 μm, at least about 75 μm, at least about 80 μm, at least about 85 μm, at least about 90 μm, or at least about 95 μm. In some embodiments, the layer of lubricating liquid 12 formed from the dispersion of the discrete portions of lubricating liquid 12 across the inner surface 10 can have a thickness of no more than about 100 μm, no more than about 95 μm, no more than about 90 μm, no more than about 85 μm, no more than about 80 μm, no more than about 75 μm, no more than about 70 μm, no more than about 65 μm, no more than about 60 μm, no more than about 55 μm, no more than about 50 μm, no more than about 45 μm, no more than about 40 μm, no more than about 35 μm, no more than about 30 μm, no more than about 25 μm, no more than about 20 μm, no more than about 15 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm.

Combinations of the above-referenced ranges for the thickness of the layer of lubricating liquid 12 formed from the dispersion of the discrete portions of lubricating liquid 12 across the inner surface 10 are also possible (e.g., at least about 1 μm and no more than about 100 μm or at least about 20 μm and no more than about 40 μm, inclusive of all values and ranges therebetween. In some embodiments, the layer of lubricating liquid 12 formed from the dispersion of the discrete portions of lubricating liquid 12 across the inner surface 10 can have a thickness of about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm about 95 μm, or about 100 μm.

In some embodiments, the apparatus 1 can include non-toxic materials, for example a lubricating liquid 12 that is non-toxic to humans and/or animals. Such non-toxic lubricating liquid 12 can thereby be disposed on the inner surface 10 of a container configured to house products formulated for human use or consumption. Such products can include, for example food products, drugs (e.g., FDA approved drugs), or health and beauty products.

The non-toxicity requirements can vary depending upon the intended use of the product in contact with the lubricious surface or liquid-encapsulated surface. For example, lubricious surfaces or liquid-encapsulated surfaces configured to be used with food products or products classified as drugs may be required to have a much higher level of non-toxicity when compared with products meant to contact only the oral mucosa (e.g., toothpaste, mouth wash, etc.), or applied topically such as, for example, health and beauty products (e.g., hair gel, shampoo, cosmetics, etc.).

In some embodiments, the lubricating liquid 12 can include materials that are a U.S. Food and Drug Administration (FDA) approved direct or indirect food additive, an FDA approved food contact substance, satisfy FDA regulatory requirements to be used as a food additive or food contact substance, and/or is an FDA GRAS material. Examples of such materials can be found within the FDA Code of Federal Regulations Title 21, located at “http: www.accessdata.fda.gov/scripts/cdrh/cfdocs/cfcfr/cfrsearch.cfm”, the entire contents of which are hereby incorporated by reference herein. In some embodiments, components of the lubricating liquid 12 can exist as a component of the contact liquid CL disposed within the inner volume of the container. In some embodiments, components of the lubricating liquid 12 can include a dietary supplement or ingredient of a dietary supplement. In some embodiments, components of the lubricating liquid 12 can also include an FDA approved food additive or color additive. In some embodiments, the lubricating liquid 12 can include materials that exist naturally in, or are derived from plants and animals. In some embodiments, the lubricating liquid 12 for use with food products may be flavorless or have a high flavor threshold of below 500 ppm, may be odorless or have high odor threshold, and/or may be substantially transparent.

In some embodiments, the lubricating liquid 12 can include an FDA approved drug ingredient, for example any ingredient included in the FDA's database of approved drugs, “http://www.accessdata.fda.gov/scripts/cder/drugsatfda/index.cfm”, the entire contents of which are hereby incorporated herein by reference. In some embodiments, the lubricating liquid 12 can include materials that satisfy FDA requirements to be used in drugs or are listed within the FDA's National Drug Discovery Code Directory, “http://www.accessdata.fda.gov/scripts/cder/ndc/default.cfm”, the entire contents of which are hereby incorporated herein by reference. In some embodiments, the lubricating liquid 12 can include inactive drug ingredients of an approved drug product as listed within FDA's database, “http://www.accessdata.fda.gov/scripts/cder/ndc/default.cfm”, the entire contents of which are hereby incorporated herein by reference. In some embodiments, the lubricating liquid 12 can include any materials that satisfy the requirement of materials that can be used with food products, and/or include a dietary supplement or ingredient of a dietary supplement.

In some embodiments, the lubricating liquid 12 can include materials which are FDA approved and satisfy FDA drug requirements, as listed within the FDA's National Drug Discovery Code Directory, and can also include FDA approved health and beauty ingredient, that satisfy FDA requirements for materials used in health and beauty products, satisfies FDA regulatory laws included in the Federal Food, Drug and Cosmetic Act (FD&C Act), or the Fair Packaging and Labeling Act (FPLA).

In some embodiments, the lubricating liquid 12 can include materials that are an FDA approved health and beauty ingredient, that satisfy FDA requirements for materials used in health and beauty products, satisfies FDA regulatory laws included in the Federal Food, Drug and Cosmetic Act (FD&C Act), or the Fair Packaging and Labeling Act (FPLA). In some embodiments, the materials can include a flavor or a fragrance.

In some embodiments, the lubricating liquid 12 described herein can include organic solids or and/or liquids that are non-toxic and fall within the following classes: lipids, waxes, fats, fibers, cellulose, derivatives of vegetable oils, essential oils, esters (such as esters of fatty acids), terpenes, monoglycerides, diglycerides, triglycerides, alcohols, fatty acid alcohols, ketones, aldehydes, proteins, sugars, salts, minerals, vitamins, carbonate, ceramic materials, alkanes, alkenes, alkynes, acyl halides, carbonates, carboxylates, carboxylic acids, methoxies, hydroperoxides, peroxides, ethers, hemiacetals, hemiaketals, acetals, ketals, orthoesters, orthocarbonate esters, phospholipids, lecithins, any other organic material or any combination thereof. In some embodiments, any of the non-toxic lubricious surfaces described herein can include non-toxic materials that are boron, phosphorous, or sulfur containing compound. Some examples of food-safe lubricating liquids are MCT oil (medium chain triglycerides), ethyl oleate, methyl laurate, propylene glycol dicaprylate/dicaprate, or vegetable oil, glycerine, squalene, or vegetable oils. In some embodiments the lubricating liquid can include solid micro-particles or nano-particles. In some embodiments, any of the non-toxic lubricious surfaces can include inorganic materials, for example ceramics, metals, metal oxides, silica, glass, plastics, any other inorganic material or combination thereof. In some embodiments, any of the non-toxic lubricious surfaces described herein can include, for example preservatives, sweeteners, color additives, flavors, spices, flavor enhancers, fat replacers, and components of formulations used to replace fats, nutrients, emulsifiers, surfactants, bulking agents, cleansing agents, depilatories, stabilizers, emulsion stabilizers, thickeners, flavor or fragrance, an ingredient of a flavor or fragrance, binders, texturizers, humectants, pH control agents, acidulants, leavening agents, anti-caking agents, anti-dandruff agents, anti-microbial agents, antiperspirants, anti-seborrheic agents, astringents, bleaching agents, denaturants, depilatories, emollients, anti-foaming agents, hair conditioning agents, hair fixing agents, hair waving agents, absorbents, anti-corrosive agents, anti-foaming agents, anti-oxidants, anti-plaque agents, anti-static agents, binding agents, buffering agents, chelating agents, cosmetic colorants, deodorants, detangling agents, emulsifying agents, film formers, foam boosting agents, gel forming agents, hair dyeing agents, hair straightening agents, keratolytics, moisturizing agents, oral care agents, pearlescent agents, plasticizers, refatting agents, skin conditioning agents, smoothing agents, soothing agents, tonics, and/or UV filters.

In some embodiments, the lubricating liquid 12 can include non-toxic materials having an average molecular weight in the range of about 100 g/mol to about 600 g/mol, which are included in the Springer Material Landolt-Bornstein database located at “http://www.springermaterials.com/docs/index.html”, or in the MatNavi database located at “www.mits.nims.go.jp/index_en.html”. In some embodiments, the lubricating liquid 12 can have a boiling point greater than 150° C. or preferably 250° C., such that the lubricating liquid 12 is not classified as volatile organic compounds (VOC's). In some embodiments, the lubricating liquid 12 can have a density that is substantially equal to the density of the contact liquid CL.

In some embodiments, the lubricating liquid 12 can have a spreading coefficient Sₒₑ₍ᵥ₎<0, where Sₒₑ₍ᵥ₎ is spreading coefficient, defined as γₑᵥ−γₑₒ−γₒᵥ, where γ is the interfacial tension between the two phases designated by subscripts, said subscripts selected from e, v, and o, where e is the contact liquid CL external to the surface and different from the lubricating liquid 12, v is vapor phase external to the surface (e.g., air), and o is the lubricating liquid 12.

In some embodiments, the lubricating liquid 12 can include one or more additives to prevent or reduce evaporation of the lubricating liquid 12. For example, the surfactant 13 can prevent or reduce evaporation of the lubricating liquid 12. In some embodiments, the surfactant 13 used to prevent or reduce evaporation of the lubricating liquid 12 can include, but is not limited to, docosenoic acid, trans-13-docosenoic acid, cis-13-docosenoic acid, nonylphenoxy tri(ethyleneoxy) ethanol, methyl 12-hydroxyoctadecanate, 1-Tetracosanol, fluorochemical “L-1006”, and any combination thereof. Examples of surfactants described herein and other surfactants which can be included in the lubricating liquid 12 can be found in White, I., “Effect of Surfactants on the Evaporation of Water Close to 100 C.” Industrial & Engineering Chemistry Fundamentals 15.1 (1976): 53-59, the content of which is incorporated herein by reference in its entirety. In some embodiments, the additives can include C₁₆H₃₃COOH, C₁₇H₃₃COOH, C₁₈H₃₃COOH, C₁₉H₃₃COOH, C₁₄H₂₉OH, C₁₆H₃₃OH, C₁₈H₃₇OH, C₂₀H₄₁OH, C₂₂H₄₅OH, C₁₇H₃₅COOCH₃, C₁₅H₃₁COOC₂H₅, C₁₆H₃₃OC₂H₄OH, C₁₈H₃₇OC₂H₄OH, C₂₀H₄₁OC₂H₄OH, C₂₂H₄₅OC₂H₄₀H, Sodium docosyl sulfate (SDS), poly(vinyl stearate), Poly (octadecyl acrylate), Poly(octadecyl methacrylate) and any combination thereof. Further examples of additives can be found in Barnes, G.T., “The potential for monolayers to reduce the evaporation of water from large water storages”, Agricultural Water Management 95.4 (2008): 339-353, the content of which is hereby incorporated herein by reference in its entirety.

The contact liquid CL, can be any liquid that is slightly miscible or immiscible with the lubricating liquid 12 such as, for example, water, edible liquids or aqueous formulations (e.g., ketchup, mustard, mayonnaise, honey, etc.), environmental fluids (e.g., sewage, rain water), bodily fluids (e.g., urine, blood, stool), or any other fluid. Alternatively, moderate or high miscibility of the lubricating liquid in the contact liquid CL can be acceptable in some embodiments, provided that it dissolves slowly enough into the contact liquid that it does not completely dissolve off of the surface into the contact liquid CL during use a use cycle (prior to replenishing the lubricating liquid). In some embodiments, the contact liquid CL can be a food product or a food ingredient such as, for example, a sticky, highly viscous, and/or non-Newtonian fluid or food product. Such food products can include, for example, candy, chocolate syrup, mash, yeast mash, beer mash, taffy, food oil, fish oil, marshmallow, dough, batter, baked goods, chewing gum, bubble gum, butter, peanut butter, jelly, jam, dough, gum, cheese, cream, cream cheese, mustard, yogurt, sour cream, curry, sauce, ajvar, currywurst sauce, salsa lizano, chutney, pebre, fish sauce, tzatziki, sriracha sauce, Vegemite®, chimichurri, HP sauce/brown sauce, harissa, kochujang, hoisan sauce, kim chi, Cholula® hot sauce, tartar sauce, tahini, hummus, shichimi, ketchup, mustard, pasta sauce, Alfredo sauce, spaghetti sauce, icing, dessert toppings, or whipped cream, liquid egg, ice cream, animal food, any other food product or combination thereof. In some embodiments, the contact liquid CL can include a topical or oral drug, a cream, an ointment, a lotion, an eye drop, an oral drug, an intravenous drug, an intramuscular drug, a suspension, a colloid, or any other material form and can include any drug included within the FDA's database of approved drugs. In some embodiments, the contact liquid CL can include a health and beauty product, for example, toothpaste, mouth washes, mouth creams, denture fixing compounds, any other oral hygiene product, sun screens, antiperspirants, anti-bacterial cleansers, lotions, creams, sunscreen, shampoo, conditioner, hair dye, moisturizers, face washes, lip gloss, liquid foundation, mascara, hair-gels, medical fluids (e.g., anti-bacterial ointments or creams), any other health or beauty product, and or any combination thereof. In some embodiments, the contact liquid CL can include any other non-Newtonian, thixotropic or highly viscous fluid, for example, laundry detergent, paint, oils, glues, waxes, petroleum products, bitumen, fabric softeners, industrial solutions, or any other contact liquid CL. Additional examples of liquid-impregnated surfaces, methods of making liquid-impregnated surfaces and applications thereof, are described in U.S. Patent Publication No. 2014/0314975 entitled “Methods and Articles for Liquid-Impregnated Surfaces with Enhanced Durability,” filed Mar. 17, 2014, the entire contents of which are hereby incorporated by reference herein.

In some embodiments, the lubricating liquid 12 can include one or multiple components or ingredients of the contact liquid CL. In some embodiments, the lubricating liquid 12 can consist of only one ingredient of the contact liquid CL. In some embodiments, the lubricating liquid can consist of multiple ingredients of the contact liquid CL. In some embodiments, the lubricating liquid can be an emulsion or a suspension that includes one or multiple components or ingredients of the contact liquid. In some embodiments, the lubricating liquid can only include one or more components or ingredients of the contact liquid CL.

In some embodiments, after charging the contact liquid CL into the inner volume of the container, the contact liquid CL can be stored for some time and then pumped or allowed to drain out of the inner volume of the container. In some embodiments, due to the increased lubricity of the lubricating liquid 12 disposed on the inner volume 10 of the container with respect to the contact liquid CL, removal of the contact liquid CL from the inner volume of the container can be accomplished quicker. In some embodiments, when the lubricating liquid 12 is dispersed across the inner surface 10 of the container, a higher percentage of the contact liquid CL can be successfully removed from the inner volume of the container, leading to a reduction in wasted contact liquid CL and a lower cost of manufacturing or otherwise processing the contact liquid CL.

As described herein, one aspect of having lubricating liquid 12 on a smooth inner surface 10 is that at least a portion of the lubricating liquid 12 may be mobile over the inner surface 10. The parameters of the mobility can depend on the properties of the lubricating liquid 12, properties of the inner surface 10, properties of the contact liquid CL, and/or other environmental conditions. For example, the speed at which at least a portion of the lubricating liquid 12 moves across the inner surface 10 may depend on its viscosity, average thickness, and how much that thickness is reduced when the lubricating liquid 12 is exposed to the contact liquid CL under conditions such as mixing, tank filling, or tank draining, which can create shear and pull lubricating liquid 12 away from the inner surface 10. Furthermore, the readiness that external forces, shearing, mixing etc., can pull, emulsify, or dissolve lubricating liquid 12 from the inner surface 10 may depend at least somewhat on the viscosity and chemistry of the lubricating liquid 12 and the contact liquid CL, and their interfacial tensions, as well as initial thickness of the lubricating liquid 12 coating on the inner surface 10. In addition, the mobility of the lubricating liquid 12 on the inner surface 10 may depend on the contact liquid CL. Where, for example, the contact liquid is emptied from the container, it may pull some of the lubricating liquid 12 off the inner surface 10. However, provided the condition of cos θ_{os(e),receding}=0 is met, a thin, thermodynamically stable layer of the lubricating liquid 12 that is less mobile may remain tightly adhered to the surface (e.g., by van der Waals forces) when in contact with the contact liquid CL, even under high sheer stresses and pressure fluctuations. As described herein, θ_{os(e), receding} is the receding contact angle of the lubricating liquid 12 (e.g., oil, subscript ‘o’) on the smooth inner surface 10 (subscript ‘s’) in the presence of the contact liquid CL (subscript ‘e’).

While the lubricating liquid 12 can be at least partially removed from the smooth inner surface 10, the surface chemistry and the lubricating liquid 12 can be selected such that the lubricious surface maintains sufficient slipperiness. In some embodiments, sufficient slipperiness can be maintained during evacuation of the contact liquid CL to allow for substantially improved drainage of the contact liquid CL from the inner volume of the container as compared with contact liquid CL drainage from a container having an un-coated inner surface 10. In some embodiments, sufficient lubricating liquid 12 (e.g., encapsulating liquid, impregnating liquid, or lubricating liquid) will survive mixing or other high-shear conditions to allow for product evacuation with little or no product sticking to the surface.

In some embodiments, the combination of liquid and solid surface can be engineered and/or selected in view of the product. In some cases, it may be useful to use a single liquid to form the lubricating layer. In others, it may be beneficial to use combination of liquids to achieve the desired metrics, including thickness, performance, etc. Combining liquids might be useful where, for example, one of the liquids is expensive, blending it with another, lower-cost liquid can reduce the overall price of the coating. In addition, it might be useful to include additives to modify the properties of the liquid. For example, in some embodiments, it might be possible to reduce the thickness of the liquid layer(s), by using lower viscosity liquids. As another example, additives can be incorporated to reduce the volatility of the lubricating liquid. In another example, additives can be incorporated to change the density of the lubricating liquid.

As described herein, mobile liquids can be used to create durable, slippery, surfaces in the context of liquid impregnated surfaces formed using textured surfaces. In such cases, it is possible to create a liquid impregnated surface by applying excess lubricating liquid that is mobile over the solid features. In such cases, the mobile excess liquid (i.e., the portion above the features) may behave like liquid on a smooth surface. In other words, as long as the appropriate thermodynamic conditions are satisfied (preferential wetting with a sufficiently low receding contact (i.e. cos θ_{os(e),receding}<θ_{c} or cos θ_{os(e),receding}<θ_{c}*), the excess mobile liquid can provide a slippery surface over and above the features. However, as in the context of a liquid on a smooth surface, the designed thickness of the excess mobile liquid film can depend on factors discussed above, and the desire for a high-performance lubricating layer can be balanced with concerns of cost, product compatibility, and regulatory context. In some embodiments, a thin mobile excess layer will be desirable. Similarly, the mobility or speed with which the excess liquid moves over the solid structure are determined by the characteristics of the liquid.

In some embodiments, removal of the contact liquid CL from the inner volume of the container can be accomplished in a shorter time when the lubricious surfaces described herein are formed on the inner surface 10 of the container. In some embodiments, compared to containers having uncoated inner surfaces 10, all or substantially all of the contact liquid CL can be drained or otherwise removed from the lubricating liquid-coated inner surface 10 of the containers described herein in less than about 95% of the time, about 90%, about 80%, about 70%, about 60%, about 50%, about 40%, about 30%, about 20%, or about 10%, inclusive of all values and ranges therebetween. When draining the contact liquid CL from conventional containers having inner surfaces that are not coated with a lubricating liquid as described herein, often less than about 90% of the contact liquid CL is successfully drained from the inner volume of the container. In some embodiments, the percentage of the contact liquid CL that can be drained or otherwise removed from the lubricating liquid-coated inner surface 10 of the containers described herein can be greater than about 90%, greater than 90%, greater than about 91%, greater than 91%, greater than about 92%, greater than 92%, greater than about 93%, greater than 93%, greater than about 94%, greater than 94%, greater than about 95%, greater than 95%, greater than about 96%, greater than 96%, greater than about 97%, greater than 97%, greater than about 98%, greater than 98%, greater than about 99%, greater than 99%, greater than about 99.5%, greater than 99.5%, greater than about 99.9%, or greater than 99.9%, inclusive of all values and ranges therebetween. In some embodiments, the percentage of the contact liquid CL that remains within the inner volume of the container for containers having a lubricating liquid-coated inner surface 10, as described herein, can be less than about 10%, less than 10%, less than about 9%, less than 9%, less than about 8%, less than 8%, less than about 7%, less than 7%, less than about 6%, less than 6%, less than about 5%, less than 5%, less than about 4%, less than 4%, less than about 3%, less than 3%, less than about 2%, less than 2%, less than about 1%, less than 1%, less than about 0.5%, less than 0.5%, less than about 0.10%, or less than 0.10%, inclusive of all values and ranges therebetween.

In some embodiments, the lubricating liquid 12 and the inner surface 10 material can be configured such that one or more of the lubricating liquid 12 components partially dissolve into the contact liquid CL resulting in a liquid mixture composition that forms a stable, slippery liquid layer between the contact liquid CL and inner surface 12 (i.e., the liquid mixture composition has a contact angle on the container surface, beneath the product that is zero, or close to zero). In other words, the lubricating liquid 12 prior to “gaining” the component from the contact liquid CL was one that does not spread on the surface and meets other conditions necessary to remain as a stable array of droplets on the surface, as described herein.

Alternatively, the lubricating liquid 12 may be a mixture that meets the conditions described herein that are necessary to remain as a stable array of droplets on the surface prior to contacting the contact liquid CL, where one or more components of the mixture dissolve into the contact liquid CL after contacting the contact liquid CL, leaving behind a liquid of a different composition that can form a stable, slippery liquid layer between the contact liquid CL and inner surface 10 (i.e., the new liquid composition has a contact angle on the container surface, beneath the product, that is zero, or close to zero on the substrate).

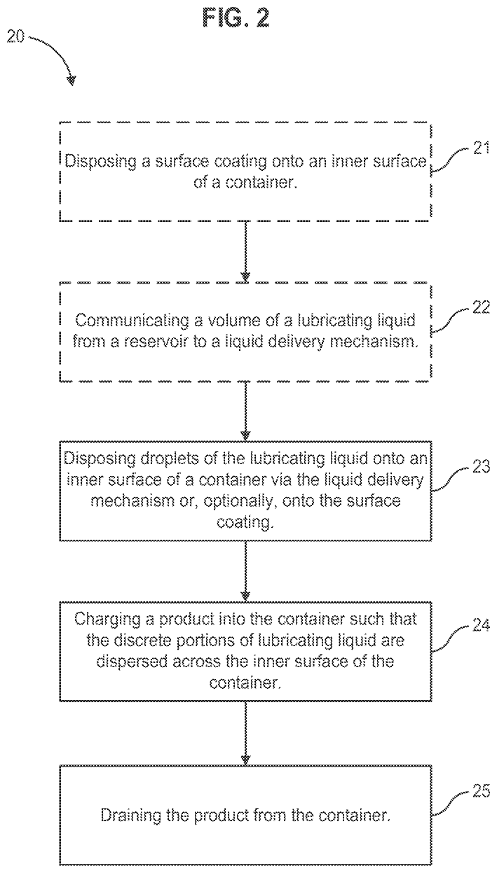

FIG. 2 illustrates a method of making a lubricious surface 20 that optionally includes a first step of disposing a surface coating onto an inner surface of a container, at 21. In some embodiments, the surface coating can include any suitable coating that facilitates the adhesion, pinning, surface tension, and/or any other manner of deposition of a lubricating liquid onto an inner surface of a container. In some embodiments, the surface coating can include perfluoroalkanes, organofluorine compounds, fluorocarbons, perfluorocarbons (PFCs), and other suitable compounds. In some embodiments, the surface coating can be disposed onto the inner surface of the container using any suitable method for depositing the surface coating, e.g., in liquid form or in powder form. In some embodiments, the surface coating can be applied permanently, semi-permanently, or temporarily onto at least a portion of the inner surface of the container. In some embodiments, the surface coating can be applied onto at least a portion of the inner surface of the container and then heated or otherwise treated to solidify the surface coating or to fuse particles of coating material, e.g., in a powder coating process. In some embodiments, after heat treatment and/or other treatment of the surface coating, the inner surface can include the surface coating. In some embodiments, the method 20 can omit step 21 such that no surface coating is first disposed onto the inner surface of the container.

The method 20 can optionally include communicating a volume of a lubricating liquid from a reservoir to a liquid delivery mechanism, at 22. The reservoir can be any suitable vessel configured to contain a supply of the lubricating liquid. The reservoir can be fluidically or operably coupled to the liquid delivery mechanism. The liquid delivery mechanism can include any suitable device configured to convey the lubricating liquid onto the inner surface of the container.

The method 20 includes disposing droplets of the lubricating liquid 12 onto the inner surface of the container or the surface coating, at 23. Disposing 23 can be carried out using any suitable equipment or device (e.g., the liquid delivery mechanisms described herein) such that discrete portions (e.g., droplets having any suitable size) can be disposed onto the inner surface in a dispersed manner. In other words, the droplets are sprayed from the device (e.g., centrifugal sprayer) onto the inner surface of the container, resulting in a suitable average distance between discrete droplets of the lubricating liquid. In addition, disposing 23 also results in suitable pinning (adhesion via any suitable mechanism or phenomenon) of the droplets of lubricating liquid onto the inner surface of the container. In other words, once sprayed onto the inner surface in a dispersed manner, the droplets stay in place regardless of the orientation of the inner surface to which the droplets are pinned. In some embodiments, dispersed droplets can merge together or coalesce to form a larger droplet. The coalescence can be caused by small dynamic disturbances and/or movement/deformation of the droplets over time after placement of the droplets. The probability of droplet coalescence increases as the size of droplets are bigger and the distance between droplets becomes smaller. The dynamic motion of merging droplets can also cause other surrounding droplets to coalescence by inducing dynamic disturbances. In addition, the lubricating liquid can include any of the materials described herein with regard to FIG. 1. For example, the lubricating liquid can be non-volatile such that the droplets remain in place on the inner surface after the disposing 23 step for an extended period without volatilizing, draining, solidifying, or otherwise losing key characteristics that allow the droplets to become a lubricious surface once dispersed across the inner surface.

The method 20 also includes charging a contact liquid CL into the container such that the discrete portions of lubricating liquid are dispersed across the inner surface of the container, at 24. The contact liquid can be any liquid, suspension, emulsion, semi-solid, or other composition described herein for which lubricity is defined as the rate at which the contact liquid travels across the lubricous surface (e.g., the lubricating liquid covering the inner surface).

Without wishing to be bound by any particular theory, charging the contact liquid into the inner volume of the container 24 can cause or partially cause the dispersion of the discrete portions of lubricating liquid across the inner surface due to an immiscibility (or low miscibility or slow miscibility) of the lubricating liquid 12 and the contact liquid CL, provided the condition of cos θ_{os(e),receding}=0 is met, or provided that θ_{os(e), receding} is sufficiently low (e.g. less than 30°, less than 25°, less than 20°, less than 15°, less than about 10°, less than about 5°, less than about 1 or less than about 0.1°). θ_{os(e), receding} is the receding contact angle of the lubricating liquid 12 (e.g., oil, subscript ‘o’) on the smooth inner surface 10 (subscript ‘s’) in the presence of the contact liquid CL (subscript ‘e’). In some embodiments, the contact liquid can be filled into the inner volume of the container from a fill port or inlet that is positioned at the bottom of the container. In some embodiments, as the contact liquid is charged into the inner volume of the container, a leading edge at the interface between the discrete portions of lubricating liquid and the contact liquid can form. In some embodiments, the leading edge of lubricating liquid can be moved up the inner surface of the container as the contact liquid is charged into the inner volume of the container. In some embodiments, the leading edge can be formed from the lubricating liquid, components that have separated out of the contact liquid, or some combination thereof.

In some embodiments, by disposing the lubricating liquid onto the inner surface of the container 23 and causing the droplets of lubricating liquid to disperse across the inner surface by charging of the contact liquid into the inner volume of the tank 24, the inner surface of the container becomes more lubricious, meaning the contact liquid moves more rapidly across the surface compared to the un-coated inner surface or meaning that the contact liquid CL has a lower roll-off angle on the coated surface compared to the uncoated, or meaning that less contact liquid CL remains behind on a the coated surface after the container has been evacuated.

Although a substantially uniform array of droplets can be favorable to ensure a sufficiently uniform thickness of a resulting film beneath the contacting liquid CL, in some embodiments where the lubricating liquid 12 has very low or 0 degree contact angle beneath the contacting liquid CL, the contacting liquid CL can push and spread the lubricating liquid beneath it as the contacting liquid CL fills the container. For example, the lubricating liquid 12 can be sprayed on only on a portion of the bottom of the container with enough total volume per unit area at the bottom that excess lubricating liquid collects at the point that contacting liquid CL makes contact with the lubricating liquid 12 and as the contacting liquid CL moves up the side of the inner surface, more lubricating liquid will spread beneath the contacting liquid CL thereby reducing the volume of the pool of the lubricating liquid 12. If a sufficient volume of the lubricating liquid 12 is supplied at the outset, there will be enough lubricating liquid 12 to form a stable film beneath all of the contacting liquid CL after filling the container.

In some embodiments, a sufficient volume of lubricating liquid 12 may be added to the top of the contacting liquid CL just before filling the tank or near the start of filling, or throughout filling of the tank, provided that the lubricating liquid preferentially wets the surface (with a contact angle of zero or close to zero beneath the product) and provided there is sufficient lubricating liquid at the point of contact between the product and the inner surface of the container to form a film between all or a significantly large portion of the contacting liquid CL and the inner surface of the container.

In some embodiments the lubricating liquid 12 may be supplied directly through the wall of the container to the inner surface near the bottom of the container, or supplied through the wall of a pipe exiting the container, or through a coupling at the exit of the container. For example, the lubricating liquid 12 may flow through several small holes or pores in the wall, or through a porous materials or membrane sealed over one or more larger holes in the wall. In such an embodiment, the lubricating liquid replenishment would preferably begin just before filling the contacting liquid CL through the bottom inlet of the container, and the flow of that lubricating liquid through the pipe wall would continue during at least a portion of the time the contacting liquid CL is filled. In this embodiment, the rate of lubricating liquid flowing to the inner surface can be varied during filling. In other words, the lubricating liquid can start flowing at a higher flow rate at the beginning of the container filling such that there is enough liquid at the beginning to spread all the way to the top of the container. This embodiment may be suitable for container that are filled from the bottom, e.g. through the same outlet the contacting liquid CL is evacuated from the container.

In some embodiments, lubricating liquid 12 that the product drags down the walls of the tank may be separated from the product near the exit of the tank, just after exiting the tank, or at some position along pipe that product exits the tank through. In some embodiments, the lubricating liquid supply mechanisms described in the previous paragraph may also serve the purpose of extracting the lubricating liquid as the contact liquid CL evacuates the container, thereby reducing contamination of the contact liquid by the lubricating liquid. Alternatively, separation of the lubricating liquid could be achieved using gravitational separators, centrifugal separators (such as nozzles centrifuges, disc-bowl centrifuges, tubular centrifuges, basket centrifuges, self-cleaning centrifuges), cyclones, hydrocyclones, cross flow filters, or field assisted separation (e.g. electric-dielectric, magnetic, or acoustic).

The method 20 also includes draining the contact liquid from the container, at 25. In some embodiments, draining 25 can be carried out by opening a valve or other similar device such that gravitation force can cause the contact liquid to drain from the inner volume of the container. In some embodiments, a pumping device or similar mechanism can be used to remove the contact liquid from the inner volume of the container.

In some embodiments, compared to containers having un-coated inner surfaces, draining the contact liquid from the container 25 can be accomplished in a shorter time when the lubricious surfaces described herein are formed on the inner surface of the container. In some embodiments, compared to containers having un-coated inner surfaces, all or substantially all of the contact liquid can be drained or otherwise removed from the lubricating liquid-coated inner surface of the containers described herein in less than about 95% of the time, about 90%, about 80%, about 70%, about 60%, about 50%, about 40%, about 30%, about 20%, or about 10%, inclusive of all values and ranges therebetween. When draining the contact liquid from conventional containers having inner surfaces that are not coated in a lubricating liquid as described herein, often less than about 90% of the contact liquid is successfully drained from the inner volume of the container. In some embodiments, the percentage of the contact liquid that can be drained or otherwise removed from the lubricating liquid-coated inner surface of the containers described herein can be greater than about 90%, 90%, about 91%, 91%, about 92%, 92%, about 93%, 93%, about 94%, 94%, about 95%, 95%, about 96%, 96%, about 97%, 97%, about 98%, 98%, about 99%, 99%, about 99.5%, 99.5%, or about 99.9%, inclusive of all values and ranges therebetween. In some embodiments, the percentage of the contact liquid that remains within the inner volume of the container for containers having a lubricating liquid-coated inner surface, as described herein, can be less than about 10%, less than 10%, less than about 9%, less than 9%, less than about 8%, less than 8%, less than about 7%, less than 7%, less than about 6%, less than 6%, less than about 5%, less than 5%, less than about 4%, less than 4%, less than about 3%, less than 3%, less than about 2%, less than 2%, less than about 1%, less than 1%, less than about 0.5%, less than 0.5%, less than about 0.1%, or less than 0.10%, inclusive of all values and ranges therebetween.

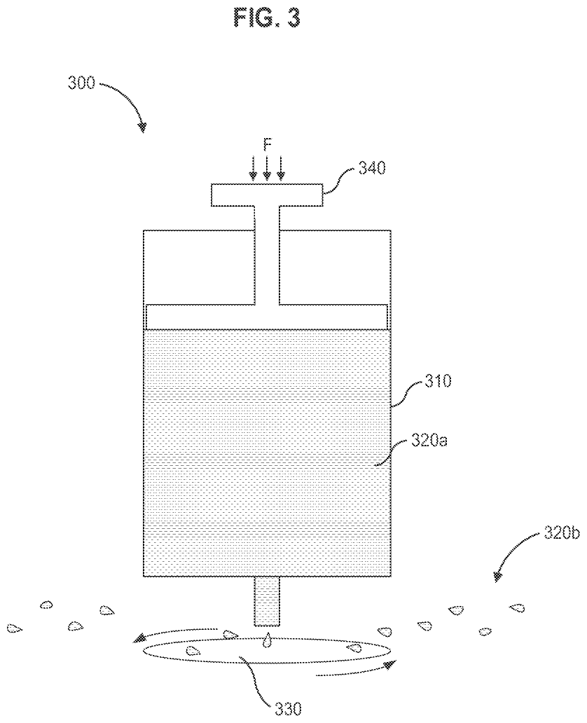

FIG. 3 illustrates a liquid delivery mechanism 300 including a reservoir 310 configured to contain a volume of lubricating liquid 320a, the reservoir fluidically coupled to a spray device 330 configured to communicate droplets of lubricating liquid 320b onto an inner surface (not shown) of a container (not shown). The liquid delivery mechanism 300 can further include a pumping mechanism 340 configured to communicate at least a portion of the volume of lubricating liquid 320a to the spray device 330. As shown, the pumping mechanism 340 operates by displacement of the volume of lubricating liquid 320a from the reservoir 310 via displacement forces, shown as the arrows F. Alternatively, any other suitable device or apparatus can be used to convey the volume of lubricating liquid 320a from the reservoir 310 to the spray device 330.

As shown in FIG. 3, the spray device 330 can be a centrifugal sprayer disk upon which discrete portions of the volume of lubricating liquid 320a can be disposed while the centrifugal sprayer disk is rotated about a center axis. In some embodiments, the spray device 330 can be a centrifugal sprayer hub. By changing various parameters of spraying such as i) height of droplet release above the centrifugal sprayer disk, ii) the chemical composition of the lubricating liquid, iii) the viscosity of the lubricating liquid, iv) the surface characteristics (e.g., roughness) of the centrifugal sprayer disk, and/or v) the rate of rotation of the centrifugal sprayer disk, droplet size and spatial distribution across the inner surface of the container can be fine-tuned to achieve the desired lubricity.

In some embodiments, the discrete portions of the volume of lubricating liquid 320a can be disposed in the center of the rotating centrifugal sprayer disk such that a nearly uniform or uniform distribution of droplets of lubricating liquid 320b are sprayed away from the center axis of the centrifugal sprayer disk. In some embodiments, the discrete portions of the volume of lubricating liquid 320a can be released from the reservoir at a release point and allowed to drop onto the rotating centrifugal sprayer disk. In some embodiments, the release point can be positioned at a distance above the surface of the centrifugal sprayer disk of between about 0.1 mm to about 20 mm, about 0.2 mm and about 19 mm, about 0.3 mm and about 18 mm, about 0.4 mm and about 17 mm, about 0.5 mm and about 16 mm, about 0.6 mm and about 15 mm, about 0.7 mm and about 14 mm, about 0.8 mm and about 13 mm, about 0.9 mm and about 12 mm, about 1 mm and about 11 mm, about 1.1 mm and about 10 mm, about 1.2 mm and about 9 mm, about 1.3 mm and about 8 mm, about 1.4 mm and about 7 mm, about 1.5 mm and about 6 mm, about 1.6 mm and about 5 mm, about 1.7 mm and about 4 mm, about 1.8 mm and about 3 mm, about 0.1 mm and about 19 mm, about 0.1 mm and about 18 mm, about 0.1 mm and about 17 mm, about 0.1 mm and about 16 mm, about 0.1 mm and about 15 mm, about 0.1 mm and about 14 mm, about 0.1 mm and about 13 mm, about 0.1 mm and about 12 mm, about 0.1 mm and about 11 mm, about 0.1 mm and about 10 mm, about 0.1 mm and about 9 mm, about 0.1 mm and about 8 mm, about 0.1 mm and about 7 mm, about 0.1 mm and about 6 mm, about 0.1 mm and about 5 mm, about 0.1 mm and about 4 mm, about 0.1 mm and about 3 mm, about 0.1 mm and about 2 mm, about 0.1 mm and about 1 mm, about 0.1 mm and about 0.5 mm, or about 0.1 mm and about 0.25 mm, inclusive of all values and ranges therebetween. In some embodiments, the release point can be positioned at a distance above the surface of the centrifugal sprayer disk of less than about 20 mm, about 19 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, about 4 mm, about 3 mm, about 2 mm, about 1 mm, about 0.9 mm, about 0.8 mm, about 0.7 mm, about 0.6 mm, about 0.5 mm, about 0.4 mm, about 0.3 mm, about 0.2 mm, or about 0.1 mm, inclusive of all values and ranges therebetween.

In some embodiments, the spray device 330 can be rotated at greater than about 100 rotations per minute (rpm), about 250 rpm, about 500 rpm, about 750 rpm, about 1,000 rpm, about 1,250 rpm, about 1,500 rpm, about 1,750 rpm, about 2,000 rpm, about 2,250 rpm, about 2,500 rpm, about 2,750 rpm, about 3,000 rpm, about 3,250 rpm, about 3,500 rpm, about 3,750 rpm, about 4,000 rpm, about 4,250 rpm, about 4,500 rpm, about 4,750 rpm, or about 5,000 rpm inclusive of all values and ranges therebetween. In some embodiments, the centrifugal sprayer disk can be rotate at a speed of between about 100 rpm and about 5,000 rpm, about 250 rpm and about 4,750 rpm, about 500 rpm and about 4,500 rpm, about 750 rpm and about 4,250 rpm, about 1,000 rpm and about 4,000 rpm, about 1,250 rpm and about 3,750 rpm, about 1,500 rpm and about 3,500 rpm, about 1,750 rpm and about 3,250 rpm, about 2,000 rpm and about 3,000 rpm, about 2,250 rpm and about 2,750 rpm, about 250 rpm and about 5,000 rpm, about 500 rpm and about 5,000 rpm, about 750 rpm and about 5,000 rpm, about 1,000 rpm and about 5,000 rpm, about 1,250 rpm and about 5,000 rpm, about 1,500 rpm and about 5,000 rpm, about 1,750 rpm and about 5,000 rpm, about 2,000 rpm and about 5,000 rpm, about 2,250 rpm and about 5,000 rpm, about 2,500 rpm and about 5,000 rpm, about 2,750 rpm and about 5,000 rpm, about 3,000 rpm and about 5,000 rpm, about 3,250 rpm and about 5,000 rpm, about 3,500 rpm and about 5,000 rpm, about 3,750 rpm and about 5,000 rpm, about 4,000 rpm and about 5,000 rpm, about 4,250 rpm and about 5,000 rpm, about 4,500 rpm and about 5,000 rpm, about 4,750 rpm and about 5,000 rpm, about 100 rpm and about 4,750 rpm, about 100 rpm and about 4,500 rpm, about 100 rpm and about 4,250 rpm, about 100 rpm and about 4,000 rpm, about 100 rpm and about 3,750 rpm, about 100 rpm and about 3,500 rpm, 100 rpm and about 3,250 rpm, about 100 rpm and about 3,000 rpm, about 100 rpm and about 2,750 rpm, about 100 rpm and about 2,500 rpm, about 100 rpm and about 2,250 rpm, about 100 rpm and about 2,000 rpm, about 100 rpm and about 1,750 rpm, about 100 rpm and about 1,500 rpm, about 100 rpm and about 1,250 rpm, about 100 rpm and about 1,000 rpm, about 100 rpm and about 750 rpm, about 100 rpm and about 500 rpm, or about 100 rpm and about 250 rpm, inclusive of all values and ranges therebetween.

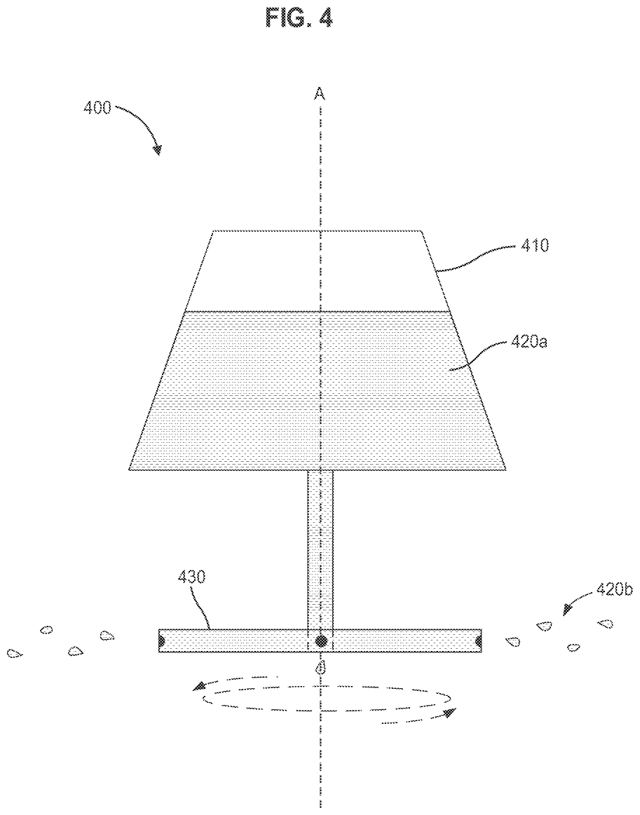

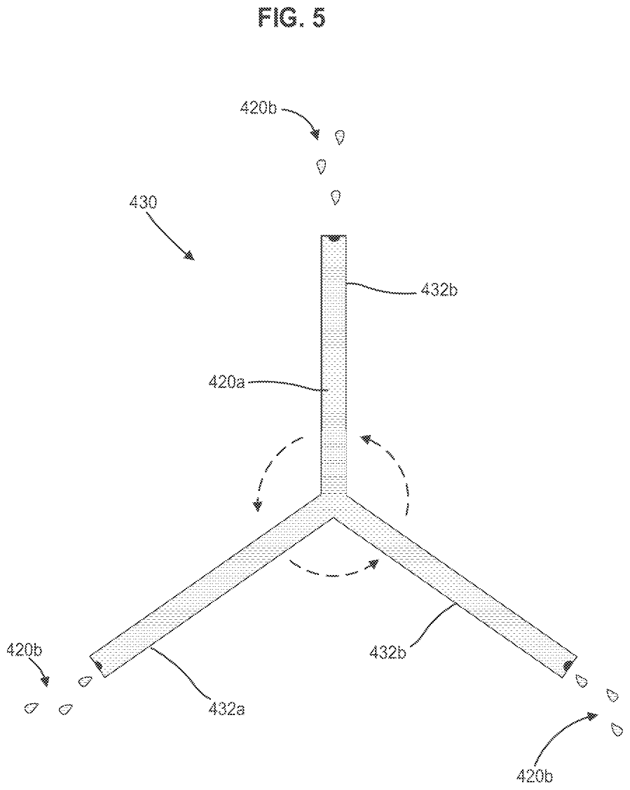

FIGS. 4 and 5 illustrate a liquid delivery mechanism 400 including a reservoir 410 configured to contain a volume of lubricating liquid 420a, the reservoir fluidically coupled to a liquid delivery device 430 configured to communicate droplets 420b of lubricating liquid onto an inner surface (not shown) of a container (not shown). The liquid delivery mechanism 400 can further include a pumping mechanism (not shown) configured to communicate at least a portion of the volume of lubricating liquid 420a from the reservoir 410 to the liquid delivery device 430.

As shown in FIGS. 4 and 5, the spray device 430 can be a centrifugal sprayer hub, composed of a set of rotating arms 432, in which the lubricating liquid 420a can be delivered through the arms while the centrifugal sprayer hub is rotated about a center axis.

As shown in FIG. 5, the liquid delivery device 430 includes a first arm 432a, a second arm 432b, and a third arm 432c (collectively referred to as arms 432) configured to rotate about an axis A. As the arms 432 rotate about the axis A, the lubricating liquid 420a is dispensed through apertures at the end of each arm 432 thereby forming droplets 420b of the lubricating liquid. In some embodiments, the lubricating liquid 420a can be dispensed through multiple apertures and/or a grid of apertures at the ends of each arm 432. In some embodiments, the lubricating liquid 420a can be delivered from the liquid reservoir 410 to the liquid delivery device 430 through conduits that pass from the liquid reservoir 410, through the liquid delivery device 430, and to the apertures at the end of each arm 432. In some embodiments, the liquid delivery device 430 can include one, two, four, five, or any number of arms 432. In some embodiments, the size of the droplets 420b can be controlled by the size of the apertures at the ends of the arms 432 and/or the tangential velocity of the arms 432 at the point of the apertures. Similarly, the velocity of the droplets 420b moving through the air after they have exited the apertures can be controlled by the tangential velocity of the arms 432 at the point of the apertures. The tangential velocity of the arms 432 at the point of the apertures is influenced by the angular velocity of the arms 432 as they rotate about the axis A and the length of the arms 432. The velocity and size of the droplets 420b determines the distance they can travel from the liquid delivery device 430 to the inner surface of a container. By changing various parameters of liquid delivery mechanism 400 such as i) the chemical composition of the lubricating liquid 420a, ii) the viscosity of the lubricating liquid 420a, iii) the size, shape, and/or number of apertures at the ends of the arms 432, and/or iv) the tangential velocity of the arms 432 at the point of the apertures, the size of the droplets 420b and spatial distribution across the inner surface of the container can be fine-tuned to achieve the desired lubricity.

In some embodiments, the centrifugal sprayer hub can be rotated at greater than about 5 rotations per minute (rpm), about 7 rpm, about 10 rpm, about 25 rpm, about 50 rpm, about 75 rpm, about 100 rpm, about 250 rpm, about 500 rpm, about 750 rpm, about 1,000 rpm, about 1,250 rpm, about 1,500 rpm, about 1,750 rpm, about 2,000 rpm, about 2,250 rpm, about 2,500 rpm, about 2,750 rpm, about 3,000 rpm, about 3,250 rpm, about 3,500 rpm, about 3,750 rpm, about 4,000 rpm, about 4,250 rpm, about 4,500 rpm, about 4,750 rpm, about 5,000 rpm, about 5,500 rpm, about 6,000 rpm, about 6,500 rpm, about 7,000 rpm, about 7,500 rpm, about 8,000 rpm, 8,500 rpm, 9,000 rpm, 9,500 rpm, 10,000 rpm, 11,000 rpm, 12,000 rpm, 13,000 rpm, 14,000 rpm, or about 15,000 rpm inclusive of all values and ranges therebetween. In some embodiments, the centrifugal sprayer hub can be rotate at a speed of between about 5 rpm and about 15,000 rpm, about 7 rpm and about 14,000 rpm, about 10 rpm and about 13,000 rpm, about 25 rpm and about 12,000 rpm, about 50 rpm and about 11,000 rpm, about 75 rpm and about 10,000 rpm, about 100 rpm and about 9,500 rpm, about 250 rpm and about 9,000 rpm, about 500 rpm and about 8,500 rpm, about 750 rpm and about 8,000 rpm, about 1,000 rpm and about 7,500 rpm, about 1,250 rpm and about 7,000 rpm, about 1,500 rpm and about 6,500 rpm, about 1,750 rpm and about 6,000 rpm, about 2,000 rpm and about 5,500 rpm, about 2,250 rpm and about 5000 rpm, about 2,500 rpm and about 4,750 rpm, about 2,750 rpm and about 4,500 rpm, about 3,000 rpm and about 4,250 rpm, about 3,250 rpm and about 4,000 rpm, about 5 rpm and about 15,000 rpm, about 7 rpm and about 15,000 rpm, about 10 rpm and about 15,000 rpm, about 25 rpm and about 15,000 rpm, about 50 rpm and about 15,000 rpm, about 75 rpm and about 15,000 rpm, about 100 rpm and about 15,000 rpm, about 250 rpm and about 15,000 rpm, about 500 rpm and about 15,000 rpm, about 750 rpm and about 15,000 rpm, about 1,000 rpm and about 15,000 rpm, about 1,250 rpm and about 15,000 rpm, about 1,500 rpm and about 15,000 rpm, about 1,750 rpm and about 15,000 rpm, about 2,000 rpm and about 15,000 rpm, about 2,250 rpm and about 15,000 rpm, about 2,500 rpm and about 15,000 rpm, about 2,750 rpm and about 15,000 rpm, about 3,000 rpm and about 15,000, about 3,250 rpm and about 15,000 rpm, about 3,500 rpm and about 15,000 rpm, about 3,750 rpm and about 15,000 rpm, about 4,000 rpm and about 15,000 rpm, about 4,250 rpm and about 15,000 rpm, about 4,500 rpm and about 15,000 rpm, about 4,750 rpm and about 15,000 rpm, about 5,000 rpm and about 15,000 rpm, about 5,500 rpm and about 15,000 rpm, about 6,000 rpm and about 15,000 rpm, about 6,500 rpm and about 15,000 rpm, about 7,000 rpm and about 15,000 rpm, about 7,500 rpm and about 15,000 rpm, about 8,000 rpm and about 15,000 rpm, about 8,500 rpm and about 15,000 rpm, about 9,000 rpm and about 15,000 rpm, about 9,500 rpm and about 15,000 rpm, about 10,000 rpm and about 15,000 rpm, about 11,000 rpm and about 15,000 rpm, about 12,000 rpm and about 15,000 rpm, about 13,000 rpm and about 15,000 rpm, about 14,000 rpm and about 15,000 rpm, about 5 rpm and about 14,000 rpm, about 5 rpm and about 13,000 rpm, about 5 rpm and about 12,000 rpm, about 5 rpm and about 11,000 rpm, about 5 rpm and about 10,000 rpm, about 5 rpm and about 9,500 rpm, 5 rpm and about 9,000 rpm, about 5 rpm and about 8,500 rpm, about 5 rpm and about 8,000 rpm, about 5 rpm and about 7,500 rpm, about 5 rpm and about 7,000 rpm, about 5 rpm and about 6,500 rpm, about 5 rpm and about 6,000 rpm, about 5 rpm and about 5,500 rpm, about 5 rpm and about 5,000 rpm, about 5 rpm and about 4,750 rpm, about 5 rpm and about 4,500 rpm, about 5 rpm and about 4,250 rpm, about 5 rpm and about 4,000 rpm, about 5 rpm and about 3,750 rpm, about 5 rpm and about 3,500 rpm, about 5 rpm and about 3,250 rpm, about 5 rpm and about 3,000 rpm, about 5 rpm and about 2,750 rpm, about 5 rpm and about 2,500 rpm, about 5 rpm and about 2,250 rpm, about 5 rpm and about 2,000 rpm, about 5 rpm and about 1,750 rpm, about 5 rpm and about 1,500 rpm, about 5 rpm and about 1,250 rpm, about 5 rpm and about 1,000 rpm, about 5 rpm and about 500 rpm, about 5 rpm and about 250 rpm, about 5 rpm and about 100 rpm, about 5 rpm and about 75 rpm, about 5 rpm and about 50 rpm, about 5 rpm and about 25 rpm, about 5 rpm and about 10 rpm, or about 5 rpm and about 7 rpm, inclusive of all values and ranges therebetween.

In some embodiments, the aperture at each arm 432 can be a single, double, triple, quadruple, or any. In some embodiments, the aperture at each arm 432 can have the size of between about 0.1 mm to about 20 mm, about 0.2 mm and about 19 mm, about 0.3 mm and about 18 mm, about 0.4 mm and about 17 mm, about 0.5 mm and about 16 mm, about 0.6 mm and about 15 mm, about 0.7 mm and about 14 mm, about 0.8 mm and about 13 mm, about 0.9 mm and about 12 mm, about 1 mm and about 11 mm, about 1.1 mm and about 10 mm, about 1.2 mm and about 9 mm, about 1.3 mm and about 8 mm, about 1.4 mm and about 7 mm, about 1.5 mm and about 6 mm, about 1.6 mm and about 5 mm, about 1.7 mm and about 4 mm, about 1.8 mm and about 3 mm, about 0.1 mm and about 19 mm, about 0.1 mm and about 18 mm, about 0.1 mm and about 17 mm, about 0.1 mm and about 16 mm, about 0.1 mm and about 15 mm, about 0.1 mm and about 14 mm, about 0.1 mm and about 13 mm, about 0.1 mm and about 12 mm, about 0.1 mm and about 11 mm, about 0.1 mm and about 10 mm, about 0.1 mm and about 9 mm, about 0.1 mm and about 8 mm, about 0.1 mm and about 7 mm, about 0.1 mm and about 6 mm, about 0.1 mm and about 5 mm, about 0.1 mm and about 4 mm, about 0.1 mm and about 3 mm, about 0.1 mm and about 2 mm, about 0.1 mm and about 1 mm, about 0.1 mm and about 0.5 mm, or about 0.1 mm and about 0.25 mm, inclusive of all values and ranges therebetween.

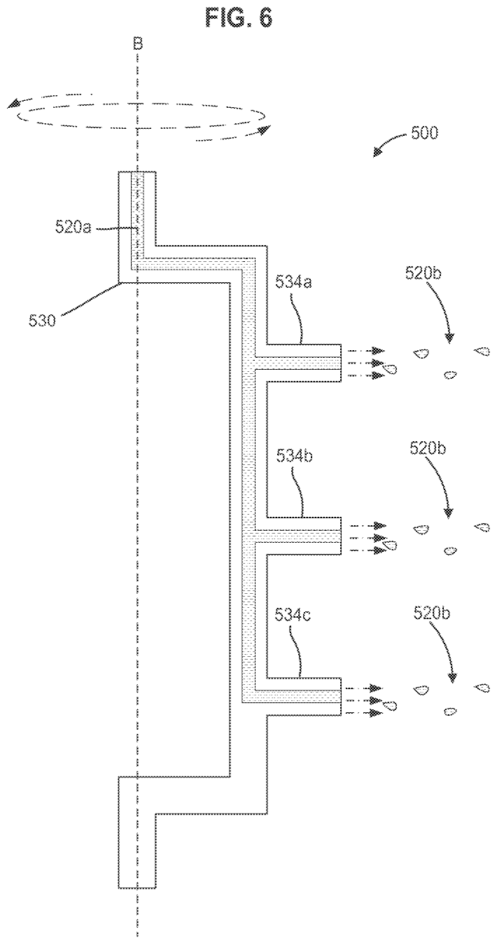

FIG. 6 illustrates a liquid delivery mechanism 500 including a liquid delivery manifold 530 configured to communicate a lubricating liquid 520a to an inner surface (not shown) of a container (not shown). The liquid delivery manifold 530 can be anchored at the top and/or bottom of the container and rotates about an axis B to communicate liquid droplets 520b of the lubricating liquid to the inner surface of the container. As shown, the liquid delivery manifold 530 includes a first sprayer 534a, a second sprayer 534b, and a third sprayer 534c (collectively referred to as sprayers 534) that discharge the liquid droplets 520b from the liquid delivery manifold 530 as it rotates about the axis B. The sprayers 534 are configured to pressurize the lubricating liquid 520a as it exits the liquid delivery manifold 530. In some embodiments, the lubricating liquid 520a is delivered to the sprayers 534 via conduits that pass from a supply (not shown) through the liquid delivery manifold 530. In some embodiments, the lubricating liquid 520a is delivered to the sprayers 534 from one or more reservoirs in the liquid delivery manifold 530 and/or the sprayers 534. Although the liquid delivery manifold 530 is shown in FIG. 6 as including three sprayers 534, in some embodiments, the liquid delivery manifold 530 can include one, two, four, five, or any number of sprayers 534.

In some embodiments, each of the sprayers 534 can include a nozzle (not shown) configured to spray the lubricating liquid 520a onto the inner surface of the container. In some embodiments, the sprayers 534 can be air assisted and/or airless sprayers. By changing various parameters of the liquid delivery mechanism 500, such as i) the distance between the nozzles on the sprayers 534 and the inner surface of the container, ii) the chemical composition of the lubricating liquid 520a, iii) the viscosity of the lubricating liquid 520a, iv) the nozzle size and/or type, and/or v) the rate of rotation of the liquid delivery manifold 530, the size of the droplet 520b and spatial distribution across the inner surface of the container can be fine-tuned to achieve the desired lubricity.

In some embodiments, the liquid delivery mechanism 500 can include a pumping mechanism (not shown) configured to deliver pressurized lubricating liquid 520a to the liquid delivery manifold 530 and the pressurized lubricating liquid 520a can then exit apertures and/or nozzles in the sprayers 534. In other words, the sprayers 534 can include apertures similar to the apertures at the end of the arms 432 described above with reference to FIGS. 4 and 5 and the pressurization of the lubricating liquid 520a can be performed upstream from the liquid delivery manifold 530. In some embodiments, the sprayers 534 can be used in the liquid delivery mechanism 430 described above instead of the apertures.

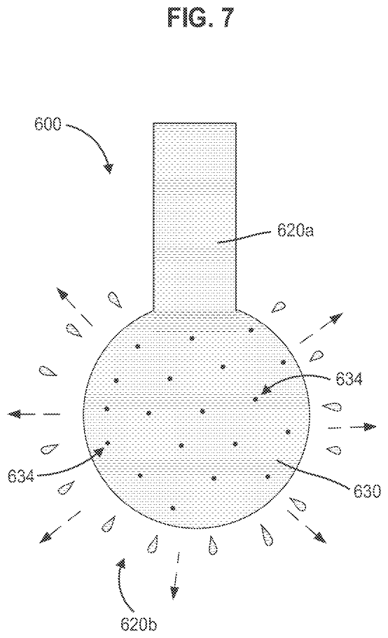

FIG. 7 illustrates a liquid delivery mechanism 600 including a spray ball 630 configured to communicate a lubricating liquid 620a onto an inner surface (not shown) of a container (not shown). The spray ball 630 can be anchored at the top and/or bottom of the container. As shown, the spray ball 630 includes a plurality of sprayers 634 that discharge the liquid droplets 620b from the spray ball 630. The sprayers 634 are configured to pressurize the lubricating liquid 620a as it exits the spray ball 630. In some embodiments, the lubricating liquid 620a is delivered to the sprayers 634 via conduits that pass from a supply (not shown) through the spray ball 630. In some embodiments, the lubricating liquid 620a is delivered to the sprayers 634 from one or more reservoirs in the spray ball 630 and/or the sprayers 634. Although the spray ball 630 is shown in FIG. 7 as including about 40 sprayers 634, in some embodiments, the spray ball 630 can include greater than one, greater than five, greater than 10, greater than 15, greater than 20, greater than 25, greater than 30, greater than 35, greater than 40, greater than 45, greater than 50, greater than 55, greater than 60, greater than 65, greater than 70, greater than 75, greater than 80, greater than 85, greater than 90, greater than 100, or any number of sprayers 634.

In some embodiments, each of the sprayers 634 can include a nozzle (not shown) configured to spray the lubricating liquid 620a onto the inner surface of the container. In some embodiments, the sprayers 634 can be air assisted and/or airless sprayers. By changing various parameters of the liquid delivery mechanism 600, such as i) the distance between the nozzles of the sprayers 634 and the inner surface of the container, ii) the chemical composition of the lubricating liquid 620a, iii) the viscosity of the lubricating liquid 620a, iv) the nozzle size and/or type, and/or v) the amount of hydrostatic head supplied to the lubricating liquid 620a, droplet size and spatial distribution across the inner surface of the container can be fine-tuned to achieve the desired lubricity.

In some embodiments, the liquid delivery mechanism 600 can include a pumping mechanism (not shown) configured to deliver pressurized lubricating liquid 620a to the spray ball 630 and the pressurized lubricating liquid 620a can then exit apertures and/or nozzles in the sprayers 634. In other words, the sprayers 634 can include apertures similar to the apertures at the ends of the arms 432 described above with reference to FIGS. 4 and 5 and the pressurization of the lubricating liquid 620a can be performed upstream from the spray ball 630. In some embodiments, the spray ball 630 can be spherical in shape. In some embodiments, the spray ball 630 can be an oblate spheroid shape. In some embodiments, the liquid delivery mechanism 600 can rotate about an axis (not shown).

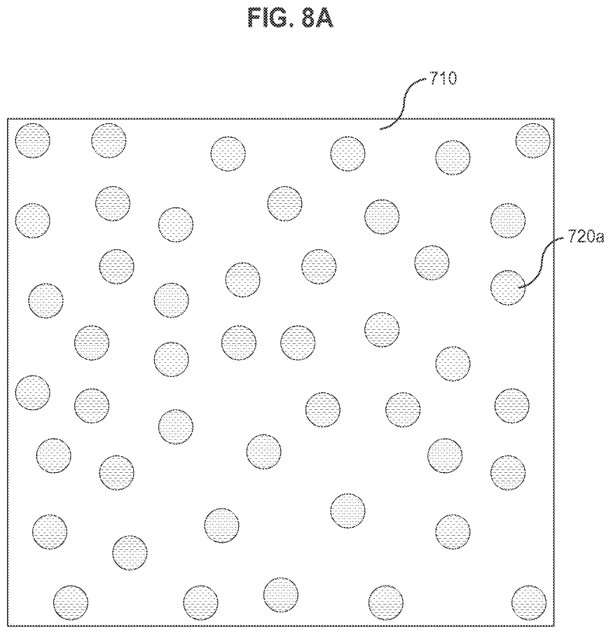

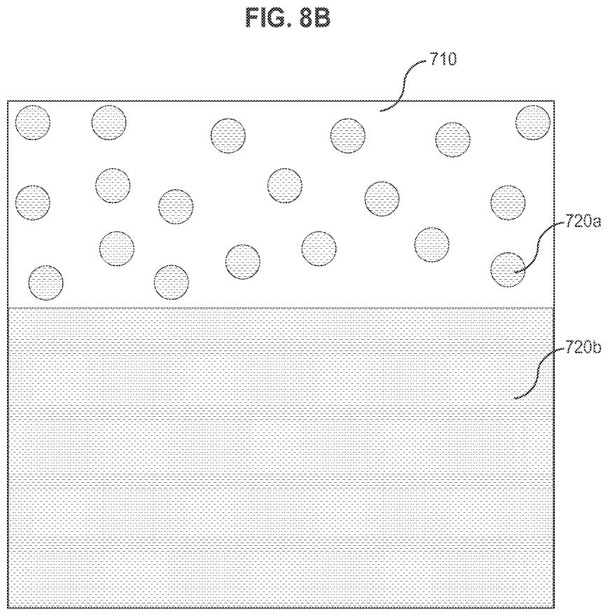

FIG. 8A illustrates an inner surface 710 of a container (not shown) having droplets of a lubricating liquid 720a disposed on the inner surface 710 and distributed substantially uniformly across the inner surface 710. As shown, the droplets of lubricating liquid 720a are pinned (e.g., adhered) to the inner surface 710 of the container and do not move or move minimally after being pinned to the inner surface 710. The dispersed droplets of lubricating liquid 720a are intentionally distributed across the inner surface 710 in a discontinuous manner, the composition of the lubricating liquid chosen such that the lubricating liquid is immiscible or substantially immiscible with a contact liquid (not shown).

FIG. 8B illustrates the inner surface of the container, a portion of which is covered by a continuous, thin layer of lubricating liquid and the remaining portion of which has droplets of the lubricating liquid disposed and distributed uniformly across the inner surface. In order to achieve a sufficiently thin finished layer of lubricating liquid on the inner surface of the container, the immiscibility of the lubricating liquid with the contact liquid can be tuned to achieve sufficient dispersion of the droplets of lubricating liquid 720a into the thin layer of lubricating liquid 720b. In other words, the immiscibility of the lubricating liquid and the contact liquid results in the dispersion of the droplets of lubricating liquid 720a from discontinuous and distributed droplets to a continuous, thin layer of lubricating liquid 720b.

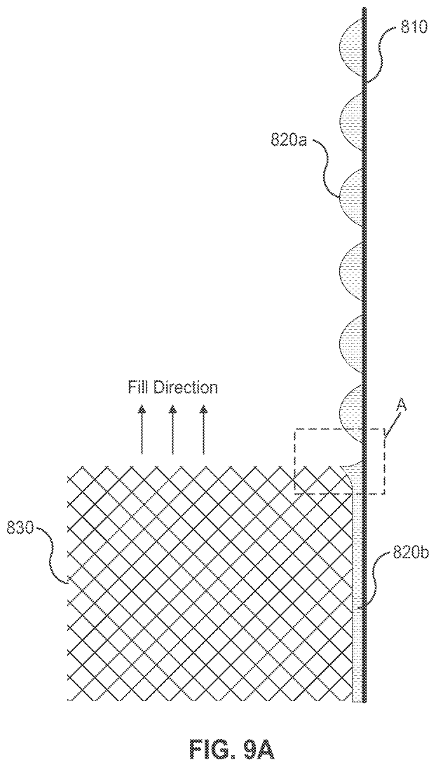

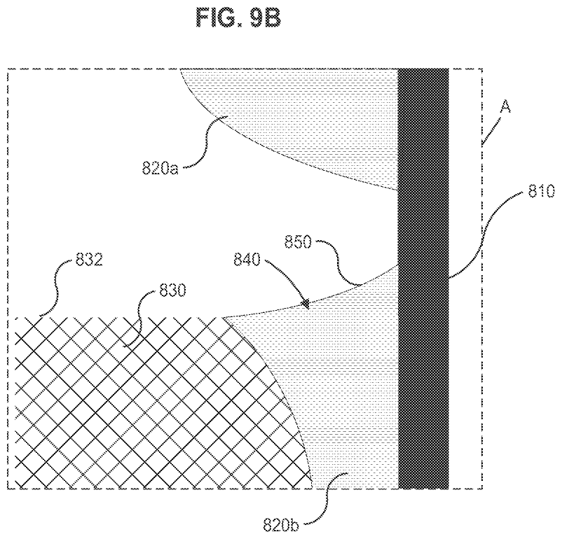

FIG. 9A illustrates an inner surface 810 of a container (not shown) on which droplets of lubricating liquid 820a are disposed, the droplets of lubricating liquid 820a being distributed in a discrete, discontinuous manner across the inner surface 810 of the container. In some embodiments, in order for discrete droplets to be stably pinned, the droplets have nonzero contact angle in the air or the external vapor phase (θ_{os(v),receding}>0 or θ_{os(v),advancing}>0) and must also be small enough that gravitational forces do not overcome pinning forces (drop sizes are listed elsewhere). Shown in FIG. 9A is the inner surface 810 of the container at a moment in time after the droplets of lubricating liquid 820a have been disposed onto the inner surface 810, and when a contact liquid 830 (i.e., the hashed region) is being charged into the container. As described with respect to FIGS. 1-9B, the lubricating liquid can be immiscible with the contact liquid 830 such that the immiscibility forms an interface 840 between a fill line 832 of the contact liquid 830 and the droplets of lubricating liquid 820a. In some embodiments, the interface 840 between the fill line 832 of the contact liquid 830 and the droplets of the lubricating liquid 830a can form into a moving edge or ridge 850 of lubricating liquid that contacts each of the droplets of lubricating liquid 820a as the ridge 850 moves across the inner surface 810 of the container. In other words, as the contact liquid 830 fills the container, the intersection between the fill line 832 and the inner surface 810 of the container will contact droplets of lubricating liquid 820a on the surface and if the fill line contacts a sufficient total volume of droplets of lubricating liquid 820a, then the lubricating liquid will accumulate into a mobile ridge 850, which extends continuously around the circumference of the container, thereby bridging the fill line 832 and the inner surface 810 such that there is minimal contact between the fill line and the inner surface 810. If at any point on the circumference of the fill line 832 this ridge does not exist, then the product fill line 832 can contact the inner surface 810 and pin at that point. In some embodiments, the pinning of contact liquid 830 to the inner surface 810 can still ensure lubricity of the system when the degree of the pinning is low enough such that a low percentage of the remaining contact liquid 830 is contacts the inner surface 810 after the evacuation of the contact liquid 830.

The rising level of contact liquid 830 in the container moves the lubricating liquid ridge 850 in the fill direction (indicated via the arrows) accumulating additional lubrication liquid from each droplet of the lubricating liquid 820a, and forming a continuous or substantially continuous layer of lubricating liquid 820b between the contact liquid 830 and the inner surface 810 of the container. In some embodiments, in order for the droplets of lubricating liquid 820a to form a continuous or substantially continuous lubricating layer beneath the contact liquid 830, θ_{os(e),receding} must be zero or very low (θ_{os(e),receding}<30° or less than 25° or less than 20° or less than 15° or less than 10° or less than 5° or less than 3° or less than 1°). In some embodiments, θₒₛ₍ᵥ₎>0 (receding or advancing) and θ_{os(e),receding}=0. In some embodiments θₒₛ₍ᵥ₎>0 (receding or advancing) and θ_{os(e),receding}<30° (or less than 25° or less than 20°, or less than 10°, or less than 5°, or less than 2°). FIG. 9B is a blown-up image of box A showing the angle, according to an embodiment, of the moving ridge 850 of lubricating liquid as the moving ridge 850 of lubricating liquid approaches a droplet of lubricating liquid 820a, as shown in FIG. 9B. As the ridge 850 of lubricating liquid reaches a droplet of lubricating liquid 820a, intermolecular and surface tension forces can cause the droplet to coalesce into the ridge 850 of lubricating liquid. As the droplet of lubricating liquid 820a coalesces into the ridge 850 of lubricating liquid, lubricating liquid from the ridge 820a spreads across the inner surface 810 longitudinally and laterally to the direction of travel of the ridge 850 (the contact liquid fill direction) and coating previously uncoated spaces of the inner surface 810 of the container.

In some embodiments, the ridge 850 of lubricating liquid may comprise wholly or partially a liquid that is different than the lubricating (impregnating or encapsulating) liquid. In some embodiments, the ridge 850 of lubricating liquid may comprise a liquid that is immiscible with the impregnating or encapsulating liquid. Alternatively, in some embodiments it can be desirable that the ridge 850 of lubricating liquid comprise liquid that is partially or completely miscible with impregnating or encapsulating liquid. In some embodiments it may be desirable that the ridge 850 of mobile liquid comprise liquid that is of a lower viscosity than the impregnating or encapsulating liquid. In some embodiments it may desirable that the ridge 850 of lubricating liquid comprise liquid that is miscible with the impregnating or encapsulating liquid, and also has a lower viscosity than the impregnating or encapsulating liquid. In such embodiments, a relatively high viscosity of impregnating or encapsulating liquid can be desirable to enhance robustness during use or storage of the product, while the low viscosity lubricating liquid in the ridge 850 of lubricating liquid can dissolve into the impregnating or encapsulating liquid in the vicinity of the fill line, thereby locally reducing the viscosity, such that the mobility parameter near the fill line is sufficiently high to allow the product to readily de-wet the inner surface of the tank during evacuation. In some embodiments it may be desirable that either the ridge 850 of lubricating liquid is shear thinning or has a nonzero yield stress or that the impregnating or encapsulating liquid is shear thinning or has nonzero yield stress. For any of the embodiments described in this section it is desirable that the ridge 850 of lubricating liquid be immiscible or substantially immiscible with the contact liquid.

At the moment in time captured in FIGS. 9A and 9B, the lubricity of the inner surface 810 beneath the contact liquid 830 is greater than the lubricity of the inner surface 810 having droplets of lubricating liquid 820a disposed thereupon, both of which are more lubricious than the inner surface 810 having no lubricating liquid disposed thereupon.

In some embodiments, if the contact liquid 830 shown in FIGS. 9A and 9B were drained from the container, it would be accomplished in a shorter time than if no lubricating liquid were disposed on the inner surface 810 of the container. In some embodiments, compared to containers having un-coated inner surfaces, all or substantially all of the contact liquid 830 can be drained or otherwise removed from the lubricating liquid-coated inner surface (e.g., substantially continuous layer of lubricating liquid 820b) of the containers described herein in less than about 95% of the time, about 90%, about 80%, about 70%, about 60%, about 50%, about 40%, about 30%, about 20%, or about 10%, inclusive of all values and ranges therebetween. When draining the contact liquid 830 from conventional containers having inner surfaces that are not coated in a lubricating liquid as described herein, often less than about 90% of the contact liquid 830 is successfully drained from the inner volume of the container. In some embodiments, the percentage of the contact liquid 830 that can be drained or otherwise removed from the lubricating liquid-coated inner surface (e.g., substantially continuous layer of lubricating liquid 820b) of the containers described herein can be greater than about 90%, 90%, about 91%, 91%, about 92%, 92%, about 93%, 93%, about 94%, 94%, about 95%, 95%, about 96%, 96%, about 97%, 97%, about 98%, 98%, about 99%, 99%, about 99.5%, 99.5%, or about 99.9%, inclusive of all values and ranges therebetween. In some embodiments, the percentage of the contact liquid 530 that remains within the inner volume of the container for containers having a lubricating liquid-coated inner surface (e.g., substantially continuous layer of lubricating liquid 820b), as described herein, can be less than about 10%, less than 10%, less than about 9%, less than 9%, less than about 8%, less than 8%, less than about 7%, less than 7%, less than about 6%, less than 6%, less than about 5%, less than 5%, less than about 4%, less than 4%, less than about 3%, less than 3%, less than about 2%, less than 2%, less than about 1%, less than 1%, less than about 0.5%, less than 0.5%, less than about 0.1%, or less than 0.10%, inclusive of all values and ranges therebetween.

To provide an overall understanding, certain illustrative embodiments have been described; however, it will be understood by one of ordinary skill in the art that the systems, apparatuses, and methods described herein can be adapted and modified to provide systems, apparatuses, and methods for other suitable applications and that other additions and modifications can be made without departing from the scope of the systems, apparatuses, and methods described herein.

The embodiments described herein have been particularly shown and described, but it will be understood that various changes in form and details may be made. Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems, apparatuses, or methods of the present disclosure.

As used herein, the term “about” and “approximately” generally mean plus or minus 10% of the value stated, for example about 250 μm would include 225 μm to 275 μm, approximately 1,000 μm would include 900 μm to 1,100 μm.

Conventional terms in the fields of materials science and engineering have been used herein. The terms are known in the art and are provided only as a non-limiting example for convenience purposes. Accordingly, the interpretation of the corresponding terms in the claims, unless stated otherwise, is not limited to any particular definition. Thus, the terms used in the claims should be given their broadest reasonable interpretation.

Although specific embodiments have been illustrated and described herein, it will be appreciated by those of ordinary skill in the art that any arrangement that is adapted to achieve the same purpose may be substituted for the specific embodiments shown. Many adaptations will be apparent to those of ordinary skill in the art. Accordingly, this application is intended to cover any adaptations or variations.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure and is submitted with the understanding that it will not be used to interpret or limit the scope or meaning of the claims.

In this Detailed Description, various features may have been grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments may be combined with each other in various combinations or permutations. The scope of the embodiments should be determined with reference to the appended claims, along with the full scope of equivalents to which such claims are entitled.

1-90. (canceled)

91. An apparatus, comprising:
a container having an inner surface;
a lubricating liquid disposed onto at least a portion of the inner surface; and
a contact liquid disposed in the container, the inner surface having a first configuration in the absence of the lubricating liquid, a second configuration in the presence of the lubricating liquid and in the absence of the contact liquid, and a third configuration in the presence of the lubricating liquid and the contact liquid,
wherein:
in the second configuration, the lubricating liquid forms droplets on the inner surface, and
in the third configuration, the contact liquid disperses the droplets of lubricating liquid such that the droplets of lubricating liquid form a thin layer of the lubricating liquid, the thin layer of lubricating liquid forming a receding contact angle with the contact liquid of less than about 30 degrees.

92. The apparatus of claim 91, wherein the lubricating liquid includes a surfactant.

93. The apparatus of claim 92, wherein the surfactant is an amphiphilic molecule that is substantially immiscible with the lubricating liquid and at least partially miscible with the contact liquid, the surfactant forming a barrier at an interface between the lubricating liquid and the contact liquid.

94. The apparatus of claim 91, wherein the lubricating liquid includes at least one of silicone oils, dimethiconol, dimethicone fluids, fisheye remover/eliminator, KE215-HP, Transtar 6737, Eastwood fish eye eliminator, a polydimethylsiloxane, a fluorosurfactant in combination with a polar liquid, a fluorosurfactant in combination with Dupont Capstone Fluorosurfactant FS-22, a fluorosurfactant in combination with Dupont Capstone Fluorosurfactant FS-30, a fluorosurfactant in combination with Dupont Capstone Fluorosurfactant FS-31, a fluorosurfactant in combination with Dupont Capstone Fluorosurfactant FS-34, a fluorosilicone, DOW Corning® FS 1265 fluid, siltech fluorosil, liquids that are emulsions, a mineral oil-PFPE emulsion, PFPE-PEG emulsion, a perfluorocarbon liquid, fluorinated vacuum oil, halogenated vacuum oil, greases, lubricants, Krytox 1506, Fromblin 06/6, a fluorinated coolant, perfluoro-tripentylamine, FC-70 manufactured by 3M, a high temperature heat transfer fluid, Galden HT, Novec fluids, an ionic liquid, a fluorinated ionic liquid that is immiscible with water, a silicone oil comprising PDMS, a fluorinated silicone oil, polyfluorosiloxane, polyorganosiloxanes, a liquid metal, a synthetic oil, a vegetable oil, a derivative of a vegetable oil, a monoglyceride, a diglyceride, a triglyceride, an electro-rheological fluid, a magneto-rheological fluid, a ferro-fluid, a dielectric liquid, a hydrocarbon liquid, a mineral oil, polyalphaolefins (PAO), fluorinated glycine, fluorinated ethers, a synthetic hydrocarbon co-oligomer, a fluorocarbon liquid, polyphenyl ether (PPE), perfluoropolyether (PFPE), perfluoroalkanes, a refrigerant, a vacuum oil, a phase-change material, a semi-liquid, polyalkylene glycol, esters of saturated fatty and dibasic acids, polyurea, grease, synovial fluid, bodily fluid, an aqueous fluid, an ionic liquid, tetrachloroethylene (perchloroethylene), phenyl isothiocyanate (phenyl mustard oil), bromo benzene, iodobenzene, obromotoluene, alpha-chloronaphthalene, alpha-bromonaphthalene, acetylene tetrabromide, 1-butyl-3-methylimidazolium bis(trifluoromethylsulfonyl) imide (bMim), tribromohydrin (1,2,3-tribromopropane), tetradecane, cyclohexane, ethylene dibromide, carbon disulfide, bromoform, methylene iodide (diiodomethane), stanolax, Squib's liquid petrolatum, p-bromotoluene, monobromobenzene, perchloroethylene, MCT oil (medium chain triglycerides), carbon disulfide, phenyl mustard oil, monoiodobenzene, triacetin, triglyceride of citric acid, alpha-monochloro-naphthalene, acetylene tetrabromide, aniline, butyl alcohol, isoamyl alcohol, n-heptyl alcohol, cresol, oleic acid, linoleic acid, amyl phthalate, cosmetic solvents composed substantially of hydrocarbons, cosmetic solvents composed of only hydrocarbons, isododecane, isohexadecane, dodecane, tetradecane, 2,2,4,6,6-Pentamehylheptane, 2,2,4,4,6,8,8-Heptamethylnonane, squalene, and squalane, hemisqualane, or isoparaffin.

95. The apparatus of claim 91, wherein the thin layer of the lubricating liquid has an average thickness on the inner surface of the container of between about 5 μm and about 75 μm.

96. The apparatus of claim 92, wherein the surfactant includes at least one of ammonium lauryl sulfate, sodium lauryl sulfate, sodium lauryl ether sulfate, sodium myreth sulfate, dioctyl sodium sulfosuccinate, perfluorooctanesulfonate, perfluorobutanesulfonate, alkyl-aryl ether phosphates, alkyl ether phosphates, sodium stearate, sodium lauroyl sarcosinate, perfluorononanoate, perfluorooctanoate, octenidine dihydrochloride, cetrimonium bromide (CTAB), cetylpyridinium chloride (CPC), benzalkonium chloride (BAC), benzethonium chloride (BZT), dimethyldioctadecylammonium chloride, dioctadecyldimethylammonium bromide (DODAB), cocamidopropyl hydroxysultaine, cocamidopropyl betaine, phospholipids phosphatidylserine, phosphatidylethanolamine, phosphatidylcholine, sphingomyelins, narrow-range ethoxylate, octaethylene glycol monododecyl ether, pentaethylene glycol monododecyl ether, nonoxynols, Triton X-100, polyethoxylated tallow amine, cocamide monoethanolamine, cocamide diethanolamine, poloxamers, glycerol monostearate, glycerol monolaurate, sorbitan monolaurate, sorbitan monostearate, sorbitan tristearate, sorbitan oleate, Tween 20, Tween 40, Tween 60, Tween 80, alkyl polyglycoside, decyl glucoside, lauryl glucoside, octyl glucoside, lauryldimethylamine oxide, PEG/PPG-18/18 dimethicone, PEG-12 dimethicone, PEG-10 dimethicone, cetyl PEG/PPG-10/1 dimethicone, polyglycerin-3 diisostearate, lauryl PEG/PPG-18/18 methicone, polyglyceryl-4 oleate, PEG-8 propylene glycol cocoate, PEG-9 dimethicone, PEG/PPG-10/15 dimethicone, alkyl polyether polydimethylsiloxane, acrylates/ethylhexyl acrylate copolymer, PEG/PPG-19/19 dimethicone, bis-PEG/PPG-14/14 dimethicone, hexyl Laurate, polyglyceryl-4 isostearate, potassium stearate, PEG/PPG-20/15 dimethicone, cetyl PEG/PPG-10/1 dimethicone, polyglyceryl-2-isostearate, PEG-3 dimethicone, PEG-9 methyl ether dimethicone, lauryl PEG-10 methyl ether dimethicone, caprylyl dimethicone ethoxy glucoside, PEG/PPG-30/10 dimethicone, glyceryl stearate, PEG-100 stearate, PEG/PPG-20/22 butyl ether dimethicone, polyglyceryl-3 disiloxane dimethicone, polyglyceryl-3 polyricinoleate, STEARETH-2, Sorbeth-20, glyceryl stearate, glyceryl caprylate, behenyl behenate, glyceryl hydroxystearate, stearyl behenate, stearyl stearate, sorbitan olivate, sorbitan sesquioleate, dicocoyl pentaerythrityl distearyl citrate, PEG-7 hydrogenated castor oil, polyoxyethylene lauryl ethen caprylate, polyglyceryl-2 diisostearate, polyglyceryl-3 oleate, stearalkonium bentonite, Quaternium-90 bentonite, cetyl alcohol, stearyl alcohol, lanolin alcohol, Stealth-2, polyglyceryl-2 sesquiisostearate, polyglyceryl-2 stearate, ethylhexylstearate, polyglyceryl-3-diisostearate, PEG-40 sorbitan peroleate, lauryl PEG-10 tris(trimethylsiloxy)silylethyl dimethicone, polyglyceryl-2 sesquioleate, polyglyceryl-6 Polyricinoleate, polyglyceryl-3 diisostearate, disteardimonium Hectorite, dimethicone PEG-8 lanolate, Oleth-10, Oleth-2, Oleth-3, Cocamide DEA, Cocamide MEA, PEG-30 dipolyhydroxystearate, polysorbate 28, Bis-(Glyceryl/Lauryl) Glyceryl Lauryl Dimethicone, Cetyl PEG/PPG-10/1 Dimethicone, Bis-PEG/PPG-14/14 Dimethicone, Polyglyceryl-3 triolivate, Polyglyceryl-6 Polyhydroxystearate, Polyglyceryl-3-Sorbityl Linseedate, Ceteareth-6, Ceteareth-25, Lauryl PEG-9 Polydimethylsiloxyethyl Dimethicone, Glyceryl dilaurate, PEG-150 Stearate, Isostearyl Diglyceryl Succinate, Polyglyceryl-2 Oleate, Sorbitan Palmitate, Sorbitan Trioleate, Glyceryl monostearate, PEG-80 Sorbitan Oleate, Cetyl PEG/PPG-7/3 Dimethicone, Sorbitan Monopalmitate, Sorbitan Monooleate, Polyglyceryl-2 Isostearate, Polyglyceryl-2 Triisostearate, Sorbitan Isostearate, Sorbitan Stearate, Laureth-9, Polysorbate 81, Polyglyceryl-10 Decaoleate, Polyglyceryl-6 Distearate, PEG-20 Methyl Glucose Sesquistearate, Methyl glucose dioleate, Methyl Glucose Sesquistearate, Polyglyceryl-3 Pentaolivate, Oleamide DEA, Polyglyceryl-10 Pentaoleate, Methoxy PEG-22/Dodecyl Glycol Copolymer, PEG-22/Dodecyl Glycol Copolymer, PEG-45/Dodecyl Glycol Copolymer, Triisostearin, Calcium Stearoyl Lactylate, Steareth-21, Lauryl PEG-8 Dimethicone, Polysorbate 80, Polysorbate 20, Polyperfluoroethoxymethoxy Difluoromethyl Distearamide, Apricot Kernel Oil Polyglyceryl-4 Esters, Quaternium-82, Lecithin, Polyglyceryl-2 sesquicaprylate, Propylene Glycol Hydroxystearate, C12-C18 Diglycerides, PEG-3 C12-18 alcohol, Liquid polysiloxane polyalkyl polyether block copolymer, Cholesterol, Polyglycerol-10 mono/dioleate, Ceteareth-4, Trideceth-12, Oleylbis(2-hydroxyethyl)methylammonium chloride, PPG-2 Isoceteth-20 Acetate, Glycereth-7 Citrate, PEG-20 Glyceryl Stearate, Cetoleth-10, Cetoleth-5, Ammonium Acryloyldimethyltaurate/Beheneth-25 Methacrylate Crosspolymer, Polypropylene Terephthalate, Acrylates/Palmeth-25 Acrylate Copolymer, Sorbitan Oleate Decylglucoside Crosspolymer, Ceteth-10, Ceteth-2, Ceteth-20, Polyglyceryl-4 Laurate/Succinate, PEG-30 Lanolin, Sodium Acrylate/Sodium Acryloyldimethyl Taurate Copolymer, Cetyl Phosphate, Potassium Cetyl Phosphate, Polyglyceryl-5 laurate, Ethanol, 2, 2′-(2-heptadecenyl-4(5H)oxazoline), Polyglyceryl-10 Laurate, Laneth-15, PEG-75 Meadowfoam Oil, Laureth-23, Oleth-20, Oleth-23, Laureth-7, Steareth-20, Bis-PEG/PPG-16/16 PEG/PPG-16/16 Dimethicone, Bis-PEG/PPG-20/5 PEG/PPG-20/5 Dimethicone, Methoxy PEG/PPG-25/4 Dimethicone, Sorbitan mono palmitate, Sorbitan mono stearate, Polyglyceryl-4 Oleyl Ether, PEG-8 beeswax, PEG-9 Laurate, PEG-14 Oleate, POE-9 Mono Oleate, PEG-8 dilaurate, Laureth-4 phosphate, Oleth-5 Phosphate, Trilaureth-4 phosphate, Ceteareth-100, Ceteareth-12, Ceteareth-20, Ceteareth-25, Ceteareth-30, Ceteth-10 phosphate, Cetyl phosphate, Polyurethane-62, Trideceth-6, Polyoxyethylene alkyl ether, Didecyldimethylammonium chloride, Sucrose Stearate, Sucrose Distearate, Sucrose Laurate, Sucrose Dilaurate, Sucrose Trilaurate, PEG-150 Distearate, C12-C18 Diglycerides, PEG-3 Lauryl Ether, PEG-10 C12-C18 alcohol, PEG-5 C12-C18 alcohol, PEG-100 Almond Glycerides, or Cetoleth-20.

97. The apparatus of claim 91, further comprising:
a liquid delivery mechanism configured to communicate the droplets of lubricating liquid to the inner surface of the container.

98. The apparatus of claim 91, wherein in the second configuration, the droplets of lubricating liquid have an average diameter between about 40 μm and about 4,000 μm.

99. An apparatus, comprising:
a container having an inner surface, the inner surface including a first section and a second section;
a lubricating liquid disposed on the first section and the second section of the inner surface; and
a contact liquid disposed in the container and covering the first section of the inner surface of the container,
wherein the lubricating liquid disposed on the first section of the inner surface exists as a thin layer of lubricating liquid, the thin layer forming a receding contact angle with the contact liquid of less than about 30 degrees, and
wherein the lubricating liquid disposed on the second section inner surface of the container exists as a plurality of droplets dispersed across the second surface of the container.

100. The apparatus of claim 99, further comprising an amphiphilic surfactant that is substantially immiscible with the lubricating liquid and at least partially miscible with the contact liquid, the surfactant forming a barrier at an interface between the lubricating liquid and the contact liquid.

101. The apparatus of claim 99, wherein the lubricating liquid includes at least one of silicone oils, dimethiconol, dimethicone fluids, fisheye remover/eliminator, KE215-HP, Transtar 6737, Eastwood fish eye eliminator, a polydimethylsiloxane, a fluorosurfactant in combination with a polar liquid, a fluorosurfactant in combination with Dupont Capstone Fluorosurfactant FS-22, a fluorosurfactant in combination with Dupont Capstone Fluorosurfactant FS-30, a fluorosurfactant in combination with Dupont Capstone Fluorosurfactant FS-31, a fluorosurfactant in combination with Dupont Capstone Fluorosurfactant FS-34, a fluorosilicone, DOW Corning@FS 1265 fluid, siltech fluorosil, liquids that are emulsions, a mineral oil-PFPE emulsion, PFPE-PEG emulsion, a perfluorocarbon liquid, fluorinated vacuum oil, halogenated vacuum oil, greases, lubricants, Krytox 1506, Fromblin 06/6, a fluorinated coolant, perfluoro-tripentylamine, FC-70 manufactured by 3M, a high temperature heat transfer fluid, Galden HT, Novec fluids, an ionic liquid, a fluorinated ionic liquid that is immiscible with water, a silicone oil comprising PDMS, a fluorinated silicone oil, polyfluorosiloxane, polyorganosiloxanes, a liquid metal, a synthetic oil, a vegetable oil, a derivative of a vegetable oil, a monoglyceride, a diglyceride, a triglyceride, an electro-rheological fluid, a magneto-rheological fluid, a ferro-fluid, a dielectric liquid, a hydrocarbon liquid, a mineral oil, polyalphaolefins (PAO), fluorinated glycine, fluorinated ethers, a synthetic hydrocarbon co-oligomer, a fluorocarbon liquid, polyphenyl ether (PPE), perfluoropolyether (PFPE), perfluoroalkanes, a refrigerant, a vacuum oil, a phase-change material, a semi-liquid, polyalkylene glycol, esters of saturated fatty and dibasic acids, polyurea, grease, synovial fluid, bodily fluid, an aqueous fluid, an ionic liquid, tetrachloroethylene (perchloroethylene), phenyl isothiocyanate (phenyl mustard oil), bromo benzene, iodobenzene, obromotoluene, alpha-chloronaphthalene, alpha-bromonaphthalene, acetylene tetrabromide, 1-butyl-3-methylimidazolium bis(trifluoromethylsulfonyl) imide (bMim), tribromohydrin (1,2,3-tribromopropane), tetradecane, cyclohexane, ethylene dibromide, carbon disulfide, bromoform, methylene iodide (diiodomethane), stanolax, Squib's liquid petrolatum, p-bromotoluene, monobromobenzene, perchloroethylene, MCT oil (medium chain triglycerides), carbon disulfide, phenyl mustard oil, monoiodobenzene, triacetin, triglyceride of citric acid, alpha-monochloro-naphthalene, acetylene tetrabromide, aniline, butyl alcohol, isoamyl alcohol, n-heptyl alcohol, cresol, oleic acid, linoleic acid, amyl phthalate, cosmetic solvents composed substantially of hydrocarbons, cosmetic solvents composed of only hydrocarbons, isododecane, isohexadecane, dodecane, tetradecane, 2,2,4,6,6-Pentamehylheptane, 2,2,4,4,6,8,8-Heptamethylnonane, squalene, and squalane, hemisqualane, or isoparaffin.

102. The apparatus of claim 99, wherein the thin layer of the lubricating liquid has an average thickness on the inner surface of the container of between about 5 μm and about 75 μm.

103. The apparatus of claim 100, wherein the surfactant includes at least one of ammonium lauryl sulfate, sodium lauryl sulfate, sodium lauryl ether sulfate, sodium myreth sulfate, dioctyl sodium sulfosuccinate, perfluorooctanesulfonate, perfluorobutanesulfonate, alkyl-aryl ether phosphates, alkyl ether phosphates, sodium stearate, sodium lauroyl sarcosinate, perfluorononanoate, perfluorooctanoate, octenidine dihydrochloride, cetrimonium bromide (CTAB), cetylpyridinium chloride (CPC), benzalkonium chloride (BAC), benzethonium chloride (BZT), dimethyldioctadecylammonium chloride, dioctadecyldimethylammonium bromide (DODAB), cocamidopropyl hydroxysultaine, cocamidopropyl betaine, phospholipids phosphatidylserine, phosphatidylethanolamine, phosphatidylcholine, sphingomyelins, narrow-range ethoxylate, octaethylene glycol monododecyl ether, pentaethylene glycol monododecyl ether, nonoxynols, Triton X-100, polyethoxylated tallow amine, cocamide monoethanolamine, cocamide diethanolamine, poloxamers, glycerol monostearate, glycerol monolaurate, sorbitan monolaurate, sorbitan monostearate, sorbitan tristearate, sorbitan oleate, Tween 20, Tween 40, Tween 60, Tween 80, alkyl polyglycoside, decyl glucoside, lauryl glucoside, octyl glucoside, lauryldimethylamine oxide, PEG/PPG-18/18 dimethicone, PEG-12 dimethicone, PEG-10 dimethicone, cetyl PEG/PPG-10/1 dimethicone, polyglycerin-3 diisostearate, lauryl PEG/PPG-18/18 methicone, polyglyceryl-4 oleate, PEG-8 propylene glycol cocoate, PEG-9 dimethicone, PEG/PPG-10/15 dimethicone, alkyl polyether polydimethylsiloxane, acrylates/ethylhexyl acrylate copolymer, PEG/PPG-19/19 dimethicone, bis-PEG/PPG-14/14 dimethicone, hexyl Laurate, polyglyceryl-4 isostearate, potassium stearate, PEG/PPG-20/15 dimethicone, cetyl PEG/PPG-10/1 dimethicone, polyglyceryl-2-isostearate, PEG-3 dimethicone, PEG-9 methyl ether dimethicone, lauryl PEG-10 methyl ether dimethicone, caprylyl dimethicone ethoxy glucoside, PEG/PPG-30/10 dimethicone, glyceryl stearate, PEG-100 stearate, PEG/PPG-20/22 butyl ether dimethicone, polyglyceryl-3 disiloxane dimethicone, polyglyceryl-3 polyricinoleate, STEARETH-2, Sorbeth-20, glyceryl stearate, glyceryl caprylate, behenyl behenate, glyceryl hydroxystearate, stearyl behenate, stearyl stearate, sorbitan olivate, sorbitan sesquioleate, dicocoyl pentaerythrityl distearyl citrate, PEG-7 hydrogenated castor oil, polyoxyethylene lauryl ethen caprylate, polyglyceryl-2 diisostearate, polyglyceryl-3 oleate, stearalkonium bentonite, Quaternium-90 bentonite, cetyl alcohol, stearyl alcohol, lanolin alcohol, Stealth-2, polyglyceryl-2 sesquiisostearate, polyglyceryl-2 stearate, ethylhexylstearate, polyglyceryl-3-diisostearate, PEG-40 sorbitan peroleate, lauryl PEG-10 tris(trimethylsiloxy)silylethyl dimethicone, polyglyceryl-2 sesquioleate, polyglyceryl-6 Polyricinoleate, polyglyceryl-3 diisostearate, disteardimonium Hectorite, dimethicone PEG-8 lanolate, Oleth-10, Oleth-2, Oleth-3, Cocamide DEA, Cocamide MEA, PEG-30 dipolyhydroxystearate, polysorbate 28, Bis-(Glyceryl/Lauryl) Glyceryl Lauryl Dimethicone, Cetyl PEG/PPG-10/1 Dimethicone, Bis-PEG/PPG-14/14 Dimethicone, Polyglyceryl-3 triolivate, Polyglyceryl-6 Polyhydroxystearate, Polyglyceryl-3-Sorbityl Linseedate, Ceteareth-6, Ceteareth-25, Lauryl PEG-9 Polydimethylsiloxyethyl Dimethicone, Glyceryl dilaurate, PEG-150 Stearate, Isostearyl Diglyceryl Succinate, Polyglyceryl-2 Oleate, Sorbitan Palmitate, Sorbitan Trioleate, Glyceryl monostearate, PEG-80 Sorbitan Oleate, Cetyl PEG/PPG-7/3 Dimethicone, Sorbitan Monopalmitate, Sorbitan Monooleate, Polyglyceryl-2 Isostearate, Polyglyceryl-2 Triisostearate, Sorbitan Isostearate, Sorbitan Stearate, Laureth-9, Polysorbate 81, Polyglyceryl-10 Decaoleate, Polyglyceryl-6 Distearate, PEG-20 Methyl Glucose Sesquistearate, Methyl glucose dioleate, Methyl Glucose Sesquistearate, Polyglyceryl-3 Pentaolivate, Oleamide DEA, Polyglyceryl-10 Pentaoleate, Methoxy PEG-22/Dodecyl Glycol Copolymer, PEG-22/Dodecyl Glycol Copolymer, PEG-45/Dodecyl Glycol Copolymer, Triisostearin, Calcium Stearoyl Lactylate, Steareth-21, Lauryl PEG-8 Dimethicone, Polysorbate 80, Polysorbate 20, Polyperfluoroethoxymethoxy Difluoromethyl Distearamide, Apricot Kernel Oil Polyglyceryl-4 Esters, Quaternium-82, Lecithin, Polyglyceryl-2 sesquicaprylate, Propylene Glycol Hydroxystearate, C12-C18 Diglycerides, PEG-3 C12-18 alcohol, Liquid polysiloxane polyalkyl polyether block copolymer, Cholesterol, Polyglycerol-10 mono/dioleate, Ceteareth-4, Trideceth-12, Oleylbis(2-hydroxyethyl)methylammonium chloride, PPG-2 Isoceteth-20 Acetate, Glycereth-7 Citrate, PEG-20 Glyceryl Stearate, Cetoleth-10, Cetoleth-5, Ammonium Acryloyldimethyltaurate/Beheneth-25 Methacrylate Crosspolymer, Polypropylene Terephthalate, Acrylates/Palmeth-25 Acrylate Copolymer, Sorbitan Oleate Decylglucoside Crosspolymer, Ceteth-10, Ceteth-2, Ceteth-20, Polyglyceryl-4 Laurate/Succinate, PEG-30 Lanolin, Sodium Acrylate/Sodium Acryloyldimethyl Taurate Copolymer, Cetyl Phosphate, Potassium Cetyl Phosphate, Polyglyceryl-5 laurate, Ethanol, 2, 2′-(2-heptadecenyl-4(5H)oxazoline), Polyglyceryl-10 Laurate, Laneth-15, PEG-75 Meadowfoam Oil, Laureth-23, Oleth-20, Oleth-23, Laureth-7, Steareth-20, Bis-PEG/PPG-16/16 PEG/PPG-16/16 Dimethicone, Bis-PEG/PPG-20/5 PEG/PPG-20/5 Dimethicone, Methoxy PEG/PPG-25/4 Dimethicone, Sorbitan mono palmitate, Sorbitan mono stearate, Polyglyceryl-4 Oleyl Ether, PEG-8 beeswax, PEG-9 Laurate, PEG-14 Oleate, POE-9 Mono Oleate, PEG-8 dilaurate, Laureth-4 phosphate, Oleth-5 Phosphate, Trilaureth-4 phosphate, Ceteareth-100, Ceteareth-12, Ceteareth-20, Ceteareth-25, Ceteareth-30, Ceteth-10 phosphate, Cetyl phosphate, Polyurethane-62, Trideceth-6, Polyoxyethylene alkyl ether, Didecyldimethylammonium chloride, Sucrose Stearate, Sucrose Distearate, Sucrose Laurate, Sucrose Dilaurate, Sucrose Trilaurate, PEG-150 Distearate, C12-C18 Diglycerides, PEG-3 Lauryl Ether, PEG-10 C12-C18 alcohol, PEG-5 C12-C18 alcohol, PEG-100 Almond Glycerides, or Cetoleth-20.

104. The apparatus of claim 99, wherein the lubricating liquid has an apparent viscosity of greater than about 10 cP at room temperature.
